(19) United States
(12) Patent Application Publication
(10) Pub. No.: US 2026/0089457 A1
(43) Pub. Date: Mar. 26, 2026

(54) PROVIDING DIGITAL ASSISTANT RESPONSES USING THREE-DIMENSIONAL AUDIO EFFECTS

(71) Applicant: Apple Inc., Cupertino, CA (US)

(72) Inventors: Elena J. NATTINGER, Menlo Park, CA (US); Anna L. BREWER, San Francisco, CA (US); Devin W. CHALMERS, Oakland, CA (US); Luis R. DELIZ CENTENO, Fremont, CA (US); Joshua J. FROST, Aptos, CA (US); Alexandria G. HESTON, San Francisco, CA (US); Lee SPARKS, Lake Forest, CA (US)

(21) Appl. No.: 19/325,339

(22) Filed: Sep. 10, 2025

Related U.S. Application Data
(60) Provisional application No. 63/699,776, filed on Sep. 26, 2024.

(51) Int. Cl. H04S 7/00; G06F 3/01; G06T 7/70; G06T 19/00; G06T 19/20; G06V 20/50; G10L 15/18; G10L 15/22

(52) U.S. Cl. CPC H04S 7/303; G06F 3/017; G06T 7/70; G06T 19/006; G06T 19/20; G06V 20/50; G10L 15/1815; G10L 15/22; G06T 2219/2004; H04S 2400/11

(57) ABSTRACT

Disclosed herein are example processes for providing digital assistant responses using three-dimensional audio effects.

### CROSS-REFERENCE TO RELATED APPLICATIONS

This application claims priority to U.S. Patent Application No. 63/699,776, entitled “PROVIDING DIGITAL ASSISTANT RESPONSES USING THREE-DIMENSIONAL AUDIO EFFECTS,” filed on Sep. 26, 2024, the content of which is hereby incorporated by reference in its entirety.

### TECHNICAL FIELD

The present disclosure generally relates to providing three-dimensional audio effects.

### BACKGROUND

The development of computer systems for interacting with and/or providing three-dimensional scenes has expanded significantly in recent years. Example three-dimensional scenes (e.g., environments) include physical scenes and extended reality scenes.

### SUMMARY

Example methods are disclosed herein. An example method includes: at a computer system that is in communication with one or more sensor devices: detecting, via the one or more sensor devices, first data; and in response to detecting, via the one or more sensor devices, the first data and after a user intent is determined based on the first data: in accordance with a determination that the user intent is a first type of user intent and a determination that a set of criteria is satisfied: audibly outputting a first spoken response that is generated based on the user intent, wherein audibly outputting the first spoken response includes: audibly outputting a first portion of the first spoken response, wherein the first portion of the first spoken response virtually emanates from a first position within a three-dimensional (3D) scene associated with the computer system, and wherein the first position is based on a first object; and after audibly outputting the first portion of the first spoken response, audibly outputting a second portion of the first spoken response, wherein the second portion of the first spoken response virtually emanates from a second position within the 3D scene that is different from the first position, and wherein the second position is based on a second object different from the first object; and in accordance with a determination that the user intent is a second type of user intent different from the first type of user intent: audibly outputting a second spoken response that is generated based on the user intent, wherein the second spoken response emanates from a default position different from the first position and the second position.

Example non-transitory computer-readable storage media are disclosed herein. An example non-transitory computer-readable storage medium stores one or more programs. The one or more programs are configured to be executed by one or more processors of a computer system that is in communication with one or more sensor devices. The one or more programs include instructions for: detecting, via the one or more sensor devices, first data; and in response to detecting, via the one or more sensor devices, the first data and after a user intent is determined based on the first data: in accordance with a determination that the user intent is a first type of user intent and a determination that a set of criteria is satisfied: audibly outputting a first spoken response that is generated based on the user intent, wherein audibly outputting the first spoken response includes: audibly outputting a first portion of the first spoken response, wherein the first portion of the first spoken response virtually emanates from a first position within a three-dimensional (3D) scene associated with the computer system, and wherein the first position is based on a first object; and after audibly outputting the first portion of the first spoken response, audibly outputting a second portion of the first spoken response, wherein the second portion of the first spoken response virtually emanates from a second position within the 3D scene that is different from the first position, and wherein the second position is based on a second object different from the first object; and in accordance with a determination that the user intent is a second type of user intent different from the first type of user intent: audibly outputting a second spoken response that is generated based on the user intent, wherein the second spoken response emanates from a default position different from the first position and the second position.

Example computer systems are disclosed herein. An example computer system is configured to communicate with one or more sensor devices. The computer system comprises: one or more processors; and memory storing one or more programs configured to be executed by the one or more processors, the one or more programs including instructions for: detecting, via the one or more sensor devices, first data; and in response to detecting, via the one or more sensor devices, the first data and after a user intent is determined based on the first data: in accordance with a determination that the user intent is a first type of user intent and a determination that a set of criteria is satisfied: audibly outputting a first spoken response that is generated based on the user intent, wherein audibly outputting the first spoken response includes: audibly outputting a first portion of the first spoken response, wherein the first portion of the first spoken response virtually emanates from a first position within a three-dimensional (3D) scene associated with the computer system, and wherein the first position is based on a first object; and after audibly outputting the first portion of the first spoken response, audibly outputting a second portion of the first spoken response, wherein the second portion of the first spoken response virtually emanates from a second position within the 3D scene that is different from the first position, and wherein the second position is based on a second object different from the first object; and in accordance with a determination that the user intent is a second type of user intent different from the first type of user intent: audibly outputting a second spoken response that is generated based on the user intent, wherein the second spoken response emanates from a default position different from the first position and the second position.

An example computer system is configured to communicate with one or more sensor devices. The computer system comprises: means for detecting, via the one or more sensor devices, first data; and means, in response to detecting, via the one or more sensor devices, the first data and after a user intent is determined based on the first data, for: in accordance with a determination that the user intent is a first type of user intent and a determination that a set of criteria is satisfied: audibly outputting a first spoken response that is generated based on the user intent, wherein audibly outputting the first spoken response includes: audibly outputting a first portion of the first spoken response, wherein the first portion of the first spoken response virtually emanates from a first position within a three-dimensional (3D) scene associated with the computer system, and wherein the first position is based on a first object; and after audibly outputting the first portion of the first spoken response, audibly outputting a second portion of the first spoken response, wherein the second portion of the first spoken response virtually emanates from a second position within the 3D scene that is different from the first position, and wherein the second position is based on a second object different from the first object; and in accordance with a determination that the user intent is a second type of user intent different from the first type of user intent: audibly outputting a second spoken response that is generated based on the user intent, wherein the second spoken response emanates from a default position different from the first position and the second position.

Audibly outputting a spoken response that virtually emanates from different positions when certain conditions are met provides for more precise and less cumbersome user-device interaction. Specifically, the virtual position of a spoken response can move in space to indicate a currently relevant and/or in-focus object, thereby assisting the user with performing an operation that corresponds to the object, directing the user's attention (e.g., gaze) towards the object, and/or increasing the user's spatial awareness of a 3D scene that they are immersed in. Audibly outputting a spoken response that emanates from a default position when other conditions are met may also provide for more precise and less cumbersome user-device interaction. Specifically, having the spoken response emanate from a default position may provide improved feedback by informing the user that the device has not identified a relevant object within the 3D scene, thereby preventing the user's attention from being directed to potentially irrelevant portions of the 3D scene and preventing the device from performing undesired operations that correspond to irrelevant objects. In this manner, the user-device interaction is made more efficient and accurate (e.g., by reducing the duration for which the device must be operated to complete a desired task, by helping the user provide accurate inputs to the device, by reducing the amount of user inputs required to operate the device as desired, by reducing repeated and/or corrective user inputs if the device does not operate as desired, and by indicating relevant information without cluttering a user interface of the device), which in turn reduces power usage and improves battery life of the device by enabling the user to use the device more quickly and efficiently.

Example methods are disclosed herein. An example method includes: at a computer system that is in communication with one or more sensor devices: detecting, via the one or more sensor devices, first data; and in response to detecting, via the one or more sensor devices, the first data and after a user intent is determined based on the first data: in accordance with a determination that a set of criteria is satisfied, wherein the set of criteria includes a first criterion that is satisfied when a first object and a second object different from the first object are respectively determined based on the user intent: audibly outputting a spoken response that is determined based on the user intent, wherein audibly outputting the spoken response includes: audibly outputting a first portion of the spoken response that virtually emanates from a first position within a three-dimensional (3D) scene associated with the computer system; and after audibly outputting the first portion of the spoken response, audibly outputting a second portion of the spoken response that virtually emanates from a second position within the 3D scene that is different from the first position, wherein: the first position is based on the first object; the second position is based on the second object; and the distance between the first position and the second position is greater than the distance between the first object and the second object.

Example non-transitory computer-readable storage media are disclosed herein. An example non-transitory computer-readable storage medium stores one or more programs. The one or more programs are configured to be executed by one or more processors of a computer system that is in communication with one or more sensor devices. The one or more programs include instructions for: detecting, via the one or more sensor devices, first data; and in response to detecting, via the one or more sensor devices, the first data and after a user intent is determined based on the first data: in accordance with a determination that a set of criteria is satisfied, wherein the set of criteria includes a first criterion that is satisfied when a first object and a second object different from the first object are respectively determined based on the user intent: audibly outputting a spoken response that is determined based on the user intent, wherein audibly outputting the spoken response includes: audibly outputting a first portion of the spoken response that virtually emanates from a first position within a three-dimensional (3D) scene associated with the computer system; and after audibly outputting the first portion of the spoken response, audibly outputting a second portion of the spoken response that virtually emanates from a second position within the 3D scene that is different from the first position, wherein: the first position is based on the first object; the second position is based on the second object; and the distance between the first position and the second position is greater than the distance between the first object and the second object.

Example computer systems are disclosed herein. An example computer system is configured to communicate with one or more sensor devices. The computer system comprises: one or more processors; and memory storing one or more programs configured to be executed by the one or more processors, the one or more programs including instructions for: detecting, via the one or more sensor devices, first data; and in response to detecting, via the one or more sensor devices, the first data and after a user intent is determined based on the first data: in accordance with a determination that a set of criteria is satisfied, wherein the set of criteria includes a first criterion that is satisfied when a first object and a second object different from the first object are respectively determined based on the user intent: audibly outputting a spoken response that is determined based on the user intent, wherein audibly outputting the spoken response includes: audibly outputting a first portion of the spoken response that virtually emanates from a first position within a three-dimensional (3D) scene associated with the computer system; and after audibly outputting the first portion of the spoken response, audibly outputting a second portion of the spoken response that virtually emanates from a second position within the 3D scene that is different from the first position, wherein: the first position is based on the first object; the second position is based on the second object; and the distance between the first position and the second position is greater than the distance between the first object and the second object.

An example computer system is configured to communicate with one or more sensor devices. The computer system comprises: means for detecting, via the one or more sensor devices, first data; and means, in response to detecting, via the one or more sensor devices, the first data and after a user intent is determined based on the first data, for: in accordance with a determination that a set of criteria is satisfied, wherein the set of criteria includes a first criterion that is satisfied when a first object and a second object different from the first object are respectively determined based on the user intent: audibly outputting a spoken response that is determined based on the user intent, wherein audibly outputting the spoken response includes: audibly outputting a first portion of the spoken response that virtually emanates from a first position within a three-dimensional (3D) scene associated with the computer system; and after audibly outputting the first portion of the spoken response, audibly outputting a second portion of the spoken response that virtually emanates from a second position within the 3D scene that is different from the first position, wherein: the first position is based on the first object; the second position is based on the second object; and the distance between the first position and the second position is greater than the distance between the first object and the second object.

Audibly outputting a spoken response that virtually emanates from positions that are further apart than the actual distance between the corresponding objects when certain conditions are met provides for more precise and less cumbersome user-device interaction. Specifically, audibly outputting the spoken response can help indicate a currently relevant and/or in-focus object and help the user distinguish between different objects (e.g., if the objects are spatially close together), thereby assisting the user with performing an operation that corresponds to a desired object and directing the user's attention (e.g., gaze) towards the desired object. In this manner, the user-device interaction is made more efficient and accurate (e.g., by reducing the duration for which the device must be operated to complete a desired task, by helping the user provide accurate inputs to the device, by reducing the amount of user inputs required to operate the device as desired, by reducing repeated and/or corrective user inputs when the device does not operate as desired, and by indicating relevant information without cluttering a user interface of the device), which in turn reduces power usage and improves battery life of the device by enabling the user to use the device more quickly and efficiently.

In some examples, the computer system is a desktop computer with an associated display. In some examples, the computer system is a portable device (e.g., a notebook computer, tablet computer, or handheld device such as a smartphone). In some examples, the computer system is a personal electronic device (e.g., a wearable electronic device, such as a watch or a head-mounted device). In some examples, the computer system has a touchpad. In some examples, the computer system has one or more cameras. In some examples, the computer system has a display generation component (e.g., a display device such as a head-mounted display, a display, a projector, a touch-sensitive display (also known as a “touch screen” or “touch-screen display”), or other device or component that presents visual content to a user, for example on or in the display generation component itself or produced from the display generation component and visible elsewhere). In some examples, the computer system does not have a display generation component and does not present visual content to a user. In some examples, the computer system has a touch-sensitive display (also known as a “touch screen” or “touch-screen display”). In some examples, the computer system has one or more eye-tracking components. In some examples, the computer system has one or more hand-tracking components. In some examples, the computer system has one or more output devices, the output devices including one or more tactile output generators and/or one or more audio output devices. In some examples, the computer system has one or more processors, memory, and one or more modules, programs or sets of instructions stored in the memory for performing various functions described herein. In some examples, the user interacts with the computer system through a stylus and/or finger contacts and gestures on the touch-sensitive surface, movement of the user's eyes and hand in space or the user's body as captured by cameras and other movement sensors, and/or voice inputs as captured by one or more audio input devices. Executable instructions for performing these functions are, optionally, included in a transitory and/or non-transitory computer-readable storage medium or other computer program product configured for execution by one or more processors.

Note that the various examples described above can be combined with any other examples described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described examples, reference should be made to the Detailed Description below, in conjunction with the following drawings in which like reference numerals refer to corresponding parts throughout the figures.

FIG. 1 is a block diagram illustrating an operating environment of a computer system for interacting with three-dimensional (3D) scenes, according to some examples.

FIG. 2 is a block diagram of a user-facing component of the computer system, according to some examples.

FIG. 3 is a block diagram of a controller of the computer system, according to some examples.

FIG. 4 illustrates an architecture for a foundation model, according to some examples.

FIGS. 5A-5L and 6A-6G illustrate spoken responses that are provided by using 3D audio effects, according to some examples.

FIG. 7 is a flow diagram of a method for providing spoken responses using 3D audio effects, according to some examples.

FIG. 8 is a flow diagram of a method for providing spoken responses using 3D audio effects, according to some examples.

### DETAILED DESCRIPTION

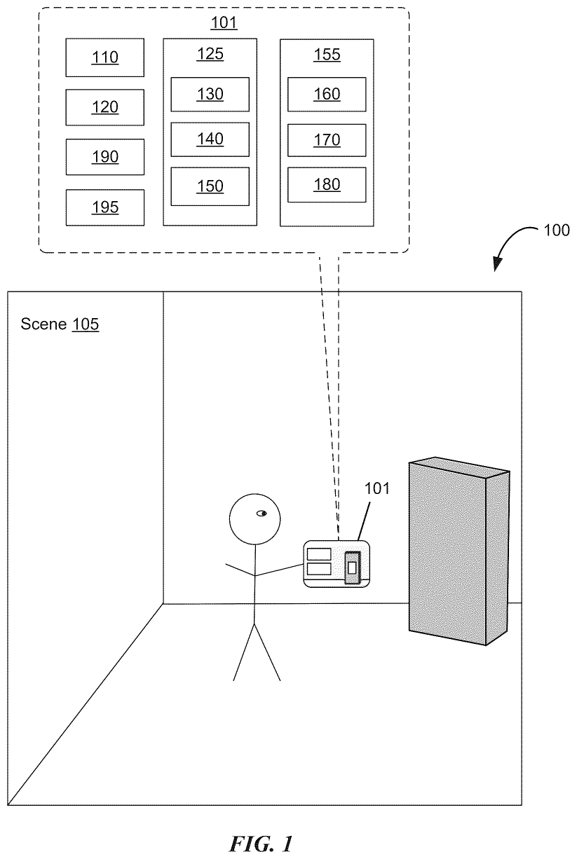

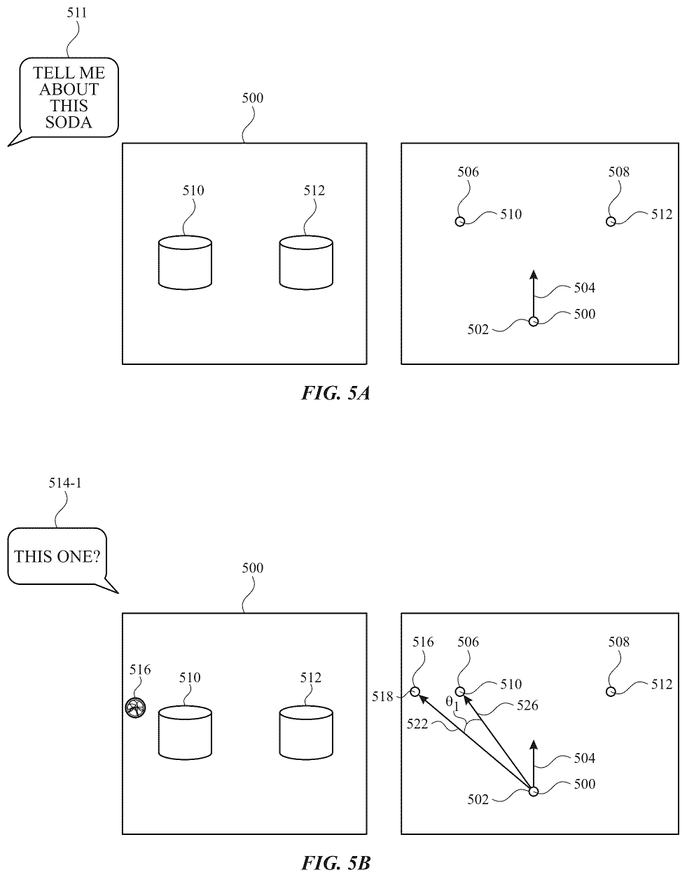

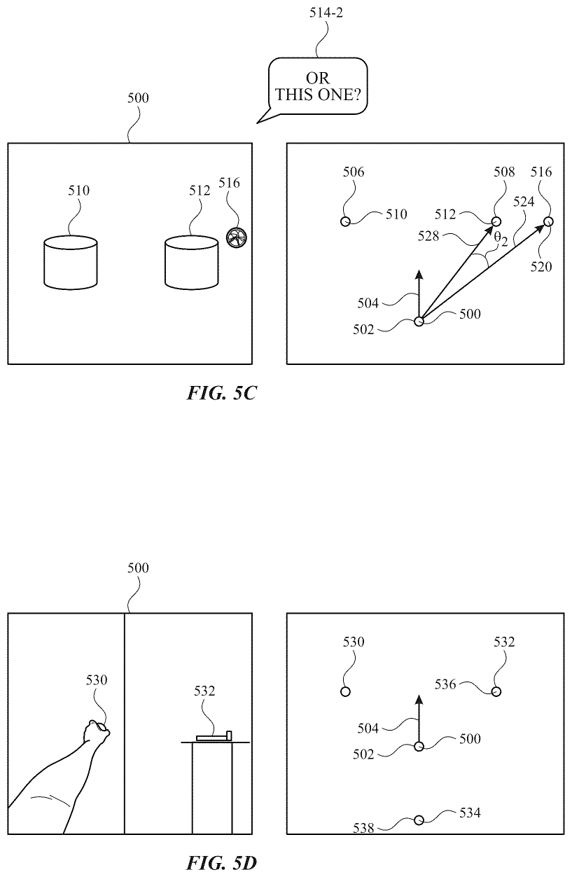

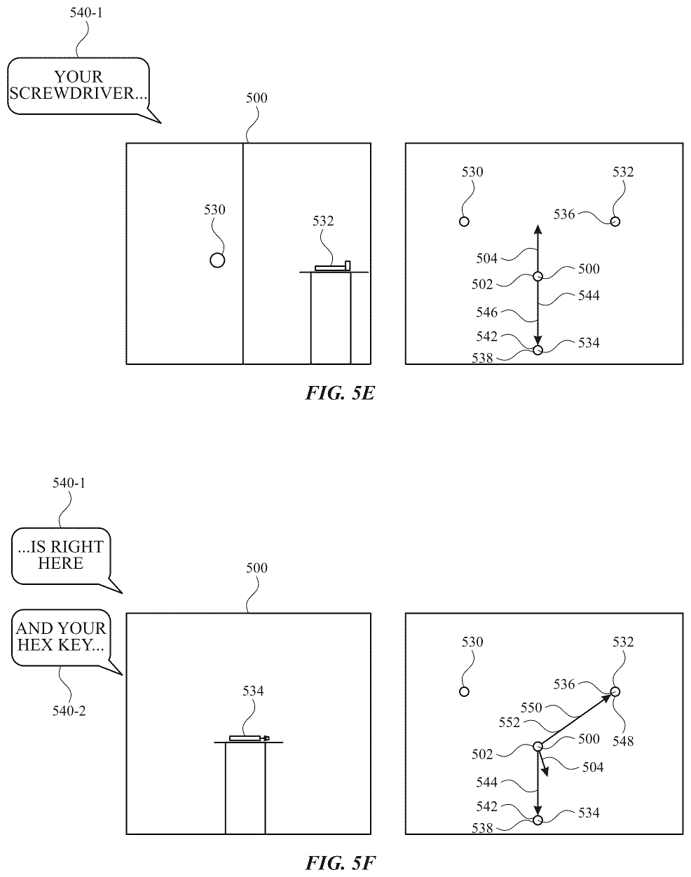

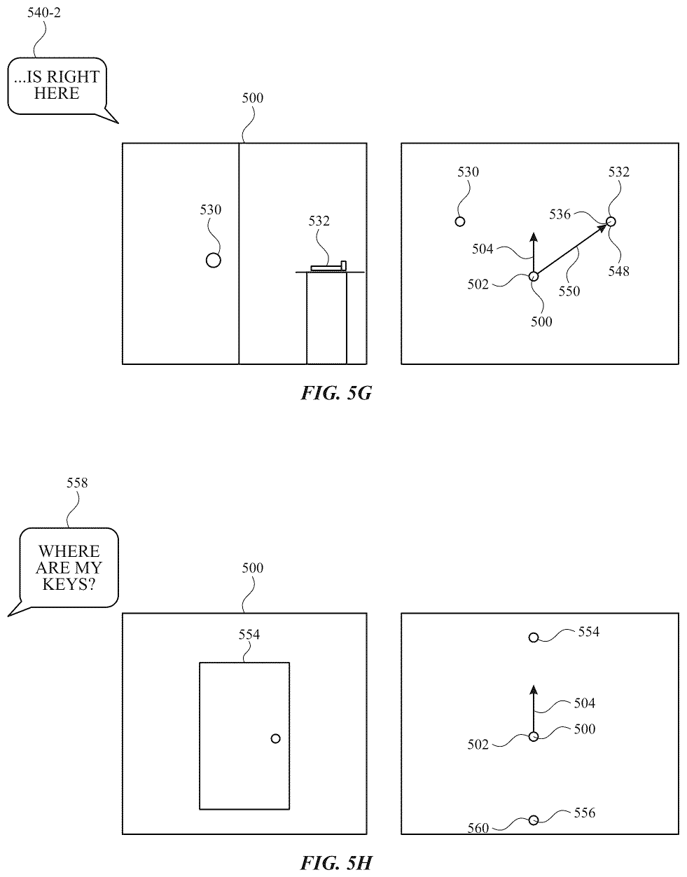

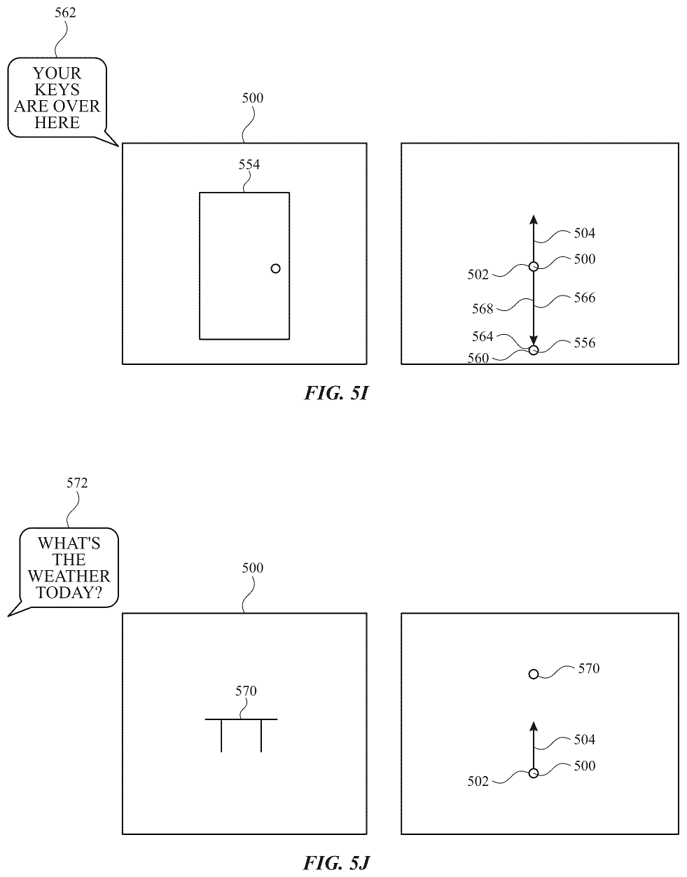

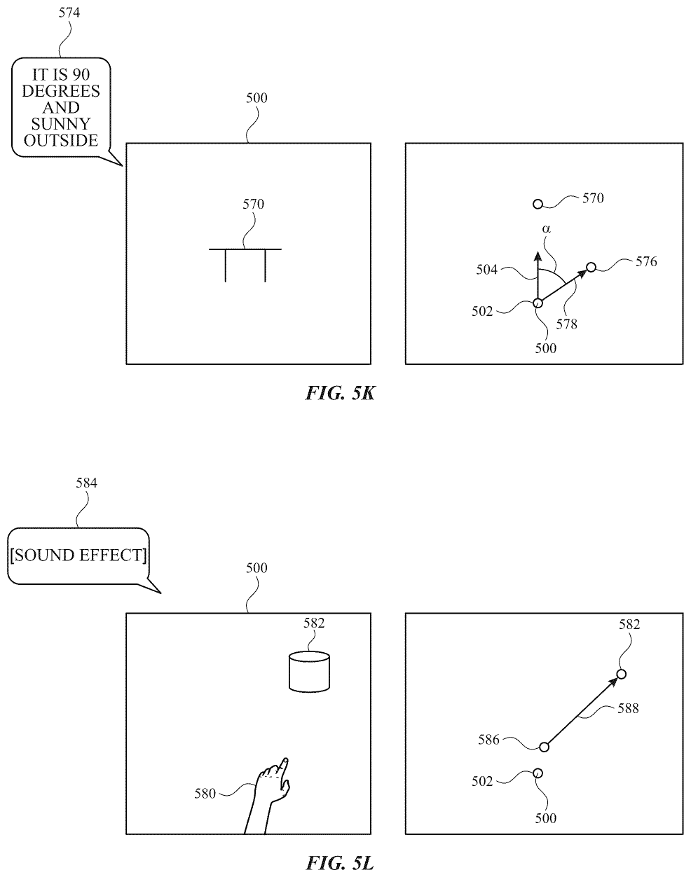

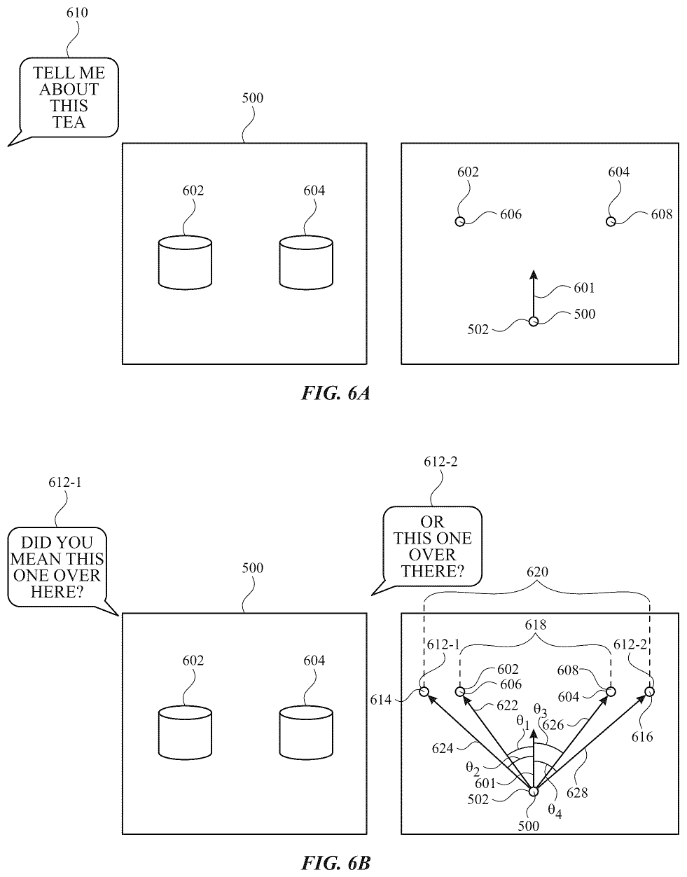

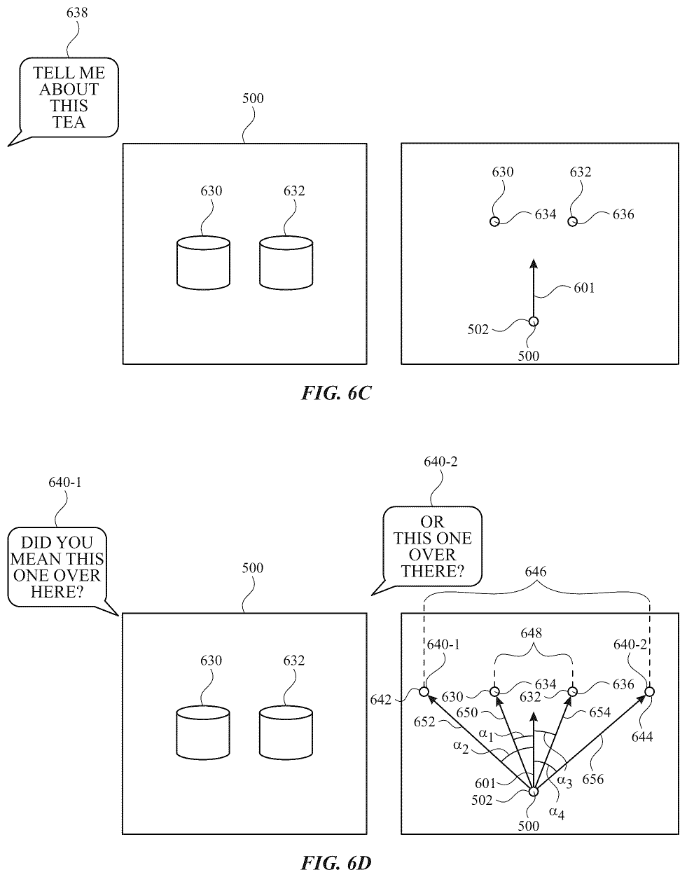

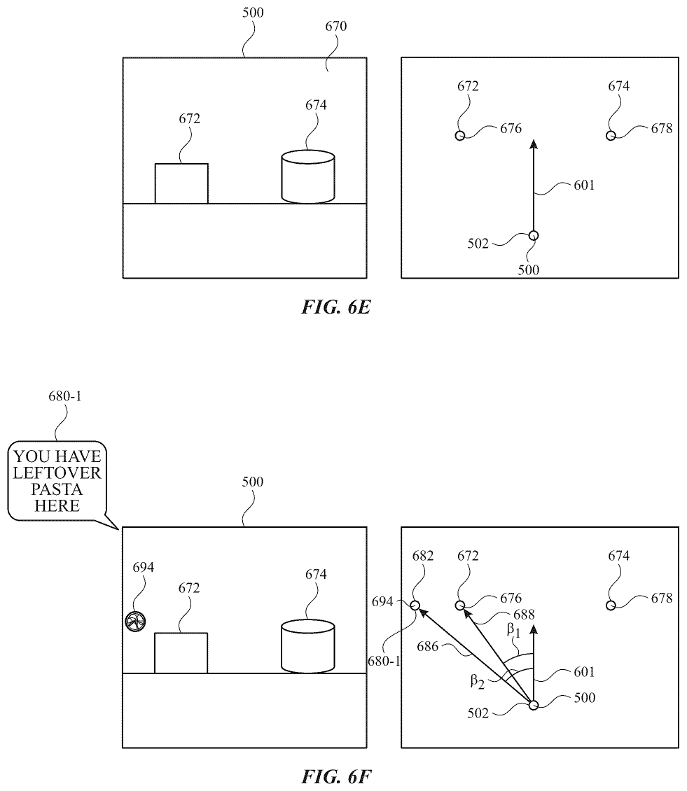

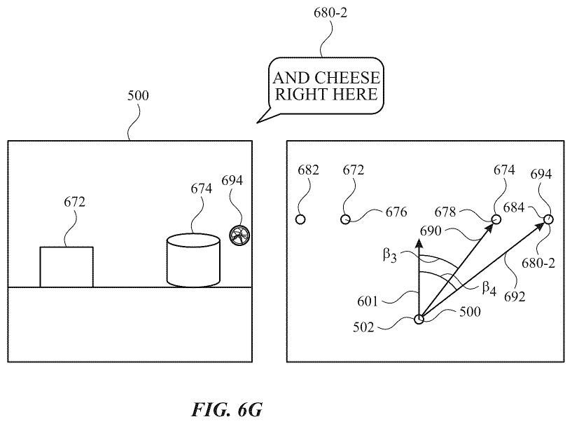

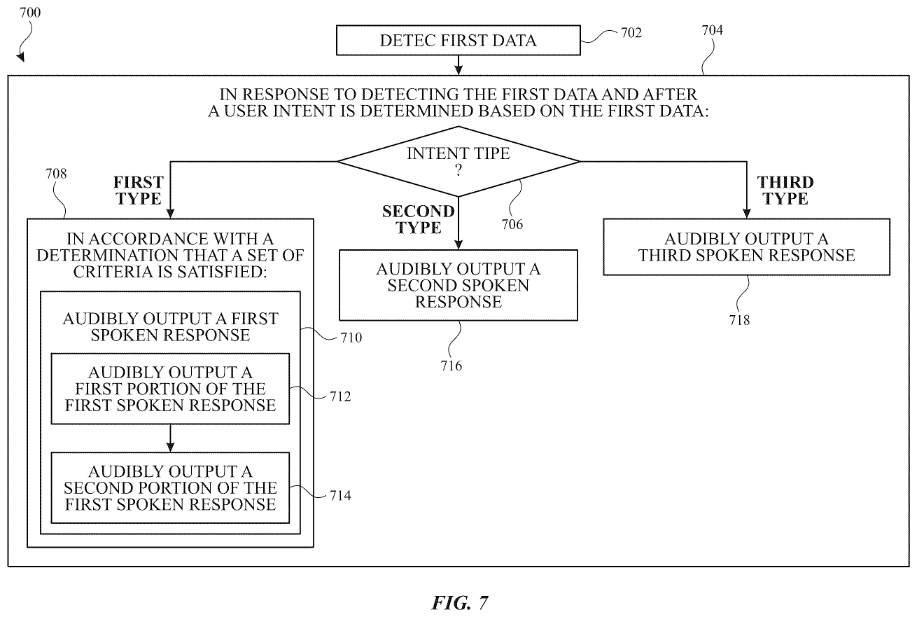

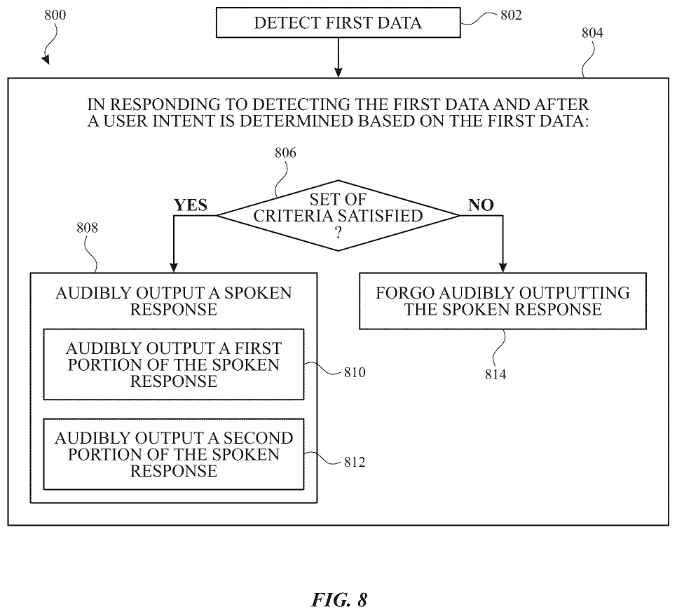

FIGS. 1-4 provide a description of example computer systems and techniques for interacting with three-dimensional scenes. FIGS. 5A-5L and 6A-6G illustrate spoken responses that are provided by using 3D audio effects. FIG. 7 is a flow diagram of a method for providing spoken responses using 3D audio effects. FIG. 8 is a flow diagram of a method for providing spoken responses using 3D audio effects. FIGS. 5A-5L are used to describe the method of FIG. 7. FIGS. 6A-6G are used to describe the method of FIG. 8.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer-readable medium claims where the system or computer-readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer-readable storage medium can repeat the steps of a method as many times as are needed to ensure that all of the contingent steps have been performed.

FIG. 1 is a block diagram illustrating an operating environment of computer system 101 for interacting with three-dimensional scenes, according to some examples. In FIG. 1, a user interacts with three-dimensional scene 105 via operating environment 100 that includes computer system 101. In some examples, computer system 101 includes controller 110 (e.g., processors of a portable electronic device or a remote server), user-facing component 120, one or more input devices 125 (e.g., eye tracking device 130, hand tracking device 140, and/or other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, audio sensors, etc.), and one or more peripheral devices 195 (e.g., home appliances, wearable devices, etc.). In some examples, one or more of input devices 125, output devices 155, sensors 190, and peripheral devices 195 are integrated with user-facing component 120 (e.g., in a head-mounted device or a handheld device).

While pertinent features of the operating environment 100 are shown in FIG. 1, those of ordinary skill in the art will appreciate from the present disclosure that various other features have not been illustrated for the sake of brevity and so as not to obscure more pertinent aspects of the examples disclosed herein.

Hardware: There are many different types of electronic systems that enable a person to sense and/or interact with three-dimensional scenes. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). Alternatively, a head-mounted system may be configured to operate without displaying content, e.g., so that the head-mounted system provides output to a user via tactile and/or auditory means. The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one example, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

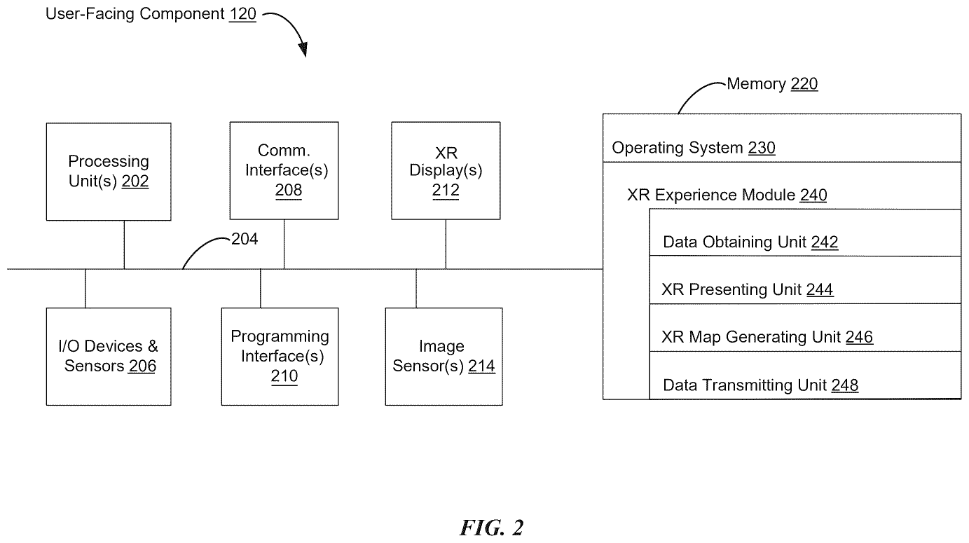

In some examples, user-facing component 120 is configured to provide a visual component of a three-dimensional scene. In some examples, user-facing component 120 includes a suitable combination of software, firmware, and/or hardware. User-facing component 120 is described in greater detail below with respect to FIG. 2. In some examples, the functionalities of controller 110 are provided by and/or combined with user-facing component 120. In some examples, user-facing component 120 provides an extended reality (XR) experience to the user while the user is virtually and/or physically present within scene 105.

In some examples, user-facing component 120 is worn on a part of the user's body (e.g., on his/her head, on his/her hand, etc.). In some examples, user-facing component 120 includes one or more XR displays provided to display the XR content. In some examples, user-facing component 120 encloses the field-of-view of the user. In some examples, user-facing component 120 is a handheld device (such as a smartphone or tablet) configured to present XR content, and the user holds the device with a display directed towards the field-of-view of the user and a camera directed towards the scene 105. In some examples, the handheld device is optionally placed within an enclosure that is worn on the head of the user. In some examples, the handheld device is optionally placed on a support (e.g., a tripod) in front of the user. In some examples, user-facing component 120 is an XR chamber, enclosure, or room configured to present XR content in which the user does not wear or hold user-facing component 120. Many user interfaces described with reference to one type of hardware for displaying XR content (e.g., a handheld device or a device on a tripod) could be implemented on another type of hardware for displaying XR content (e.g., a head-mounted device (HMD) or other wearable computing device). For example, a user interface showing interactions with XR content triggered based on interactions that happen in a space in front of a handheld or tripod-mounted device could similarly be implemented with an HMD where the interactions happen in a space in front of the HMD and the responses of the XR content are displayed via the HMD. Similarly, a user interface showing interactions with XR content triggered based on movement of a handheld or tripod-mounted device relative to the physical environment (e.g., scene 105 or a part of the user's body (e.g., the user's eye(s), head, or hand)) could similarly be implemented with an HMD where the movement is caused by movement of the HMD relative to the physical environment (e.g., scene 105 or a part of the user's body (e.g., the user's eye(s), head, or hand)).

FIG. 2 is a block diagram of user-facing component 120, according to some examples. While certain specific features are illustrated, those skilled in the art will appreciate from the present disclosure that various other features have not been illustrated for the sake of brevity, and so as not to obscure more pertinent aspects of the examples disclosed herein. Moreover, FIG. 2 is intended more as a functional description of the various features that could be present in a particular implementation, as opposed to a structural schematic of the examples described herein. As recognized by those of ordinary skill in the art, components shown separately could be combined and some components could be separated. For example, some functional modules shown separately in FIG. 2 could be implemented in a single module and the various functions of single functional blocks could be implemented by one or more functional blocks in various examples. The actual number of modules and the division of particular functions and how features are allocated among them will vary from one implementation to another and, in some examples, depends in part on the particular combination of hardware, software, and/or firmware chosen for a particular implementation.

In some examples, user-facing component 120 (e.g., HMD) includes one or more processing units 202 (e.g., microprocessors, ASICs, FPGAs, GPUs, CPUs, processing cores, and/or the like), one or more input/output (I/O) devices and sensors 206, one or more communication interfaces 208 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 210, one or more XR displays 212, one or more optional interior- and/or exterior-facing image sensors 214, a memory 220, and one or more communication buses 204 for interconnecting these and various other components.

In some examples, one or more communication buses 204 include circuitry that interconnects and controls communications between system components. In some examples, one or more I/O devices and sensors 206 include at least one of an inertial measurement unit (IMU), an accelerometer, a gyroscope, a thermometer, one or more biometric sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some examples, one or more XR displays 212 are configured to provide an XR experience to the user. In some examples, one or more XR displays 212 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some examples, one or more XR displays 212 correspond to diffractive, reflective, polarized, holographic, etc. waveguide displays. For example, user-facing component 120 (e.g., HMD) includes a single XR display. In another example, user-facing component 120 includes an XR display for each eye of the user. In some examples, one or more XR displays 212 are capable of presenting XR content. In some examples, one or more XR displays 212 are omitted from user-facing component 120. For example, user-facing component 120 does not include any component that is configured to display content (or does not include any component that is configured to display XR content) and user-facing component 120 provides output via audio and/or haptic output types.

In some examples, one or more image sensors 214 are configured to obtain image data that corresponds to at least a portion of the face of the user that includes the eyes of the user (and may be referred to as an eye-tracking camera). In some examples, one or more image sensors 214 are configured to obtain image data that corresponds to at least a portion of the user's hand(s) and, optionally, arm(s) of the user (and may be referred to as a hand-tracking camera). In some examples, one or more image sensors 214 are configured to be forward-facing to obtain image data that corresponds to the scene as would be viewed by the user if user-facing component 120 (e.g., HMD) was not present (and may be referred to as a scene camera). One or more optional image sensors 214 can include one or more RGB cameras (e.g., with a complementary metal-oxide-semiconductor (CMOS) image sensor or a charge-coupled device (CCD) image sensor), one or more infrared (IR) cameras, one or more event-based cameras, and/or the like.

Memory 220 includes high-speed random-access memory, such as DRAM, SRAM, DDR RAM, or other random-access solid-state memory devices. In some examples, memory 220 includes non-volatile memory, such as one or more magnetic disk storage devices, optical disk storage devices, flash memory devices, or other non-volatile solid-state storage devices. Memory 220 optionally includes one or more storage devices remotely located from the one or more processing units 202. Memory 220 comprises a non-transitory computer-readable storage medium. In some examples, memory 220 or the non-transitory computer-readable storage medium of memory 220 stores the following programs, modules and data structures, or a subset thereof, including optional operating system 230 and XR experience module 240.

Operating system 230 includes instructions for handling various basic system services and for performing hardware dependent tasks. In some examples, XR experience module 240 is configured to present XR content to the user via one or more XR displays 212 or one or more speakers. To that end, in various examples, XR experience module 240 includes data obtaining unit 242, XR presenting unit 244, XR map generating unit 246, and data transmitting unit 248.

In some examples, data obtaining unit 242 is configured to obtain data (e.g., presentation data, interaction data, sensor data, location data, etc.) from at least controller 110 of FIG. 1. To that end, in various examples, data obtaining unit 242 includes instructions and/or logic therefor, and heuristics and metadata therefor.

In some examples, XR presenting unit 244 is configured to present XR content via one or more XR displays 212 or one or more speakers. To that end, in various examples, XR presenting unit 244 includes instructions and/or logic therefor, and heuristics and metadata therefor.

In some examples, XR map generating unit 246 is configured to generate an XR map (e.g., a 3D map of the extended reality scene or a map of the physical environment into which computer-generated objects can placed) based on media content data. To that end, in various examples, XR map generating unit 246 includes instructions and/or logic therefor, and heuristics and metadata therefor.

In some examples, the data transmitting unit 248 is configured to transmit data (e.g., presentation data, location data, sensor data, etc.) to at least controller 110, and optionally one or more of input devices 125, output devices 155, sensors 190, and/or peripheral devices 195. To that end, in various examples, data transmitting unit 248 includes instructions and/or logic therefor, and heuristics and metadata therefor.

Although data obtaining unit 242, XR presenting unit 244, XR map generating unit 246, and data transmitting unit 248 are shown as residing on a single device (e.g., user-facing component 120 of FIG. 1), in other examples, any combination of data obtaining unit 242, XR presenting unit 244, XR map generating unit 246, and data transmitting unit 248 may reside on separate computing devices.

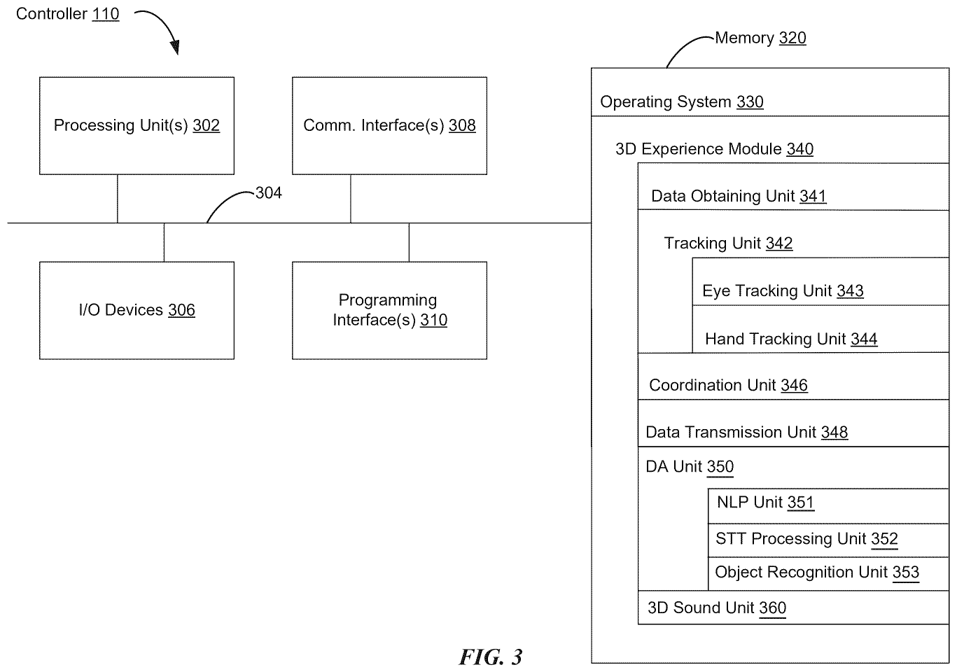

Returning to FIG. 1, controller 110 is configured to manage and coordinate a user's experience with respect to a three-dimensional scene. In some examples, controller 110 includes a suitable combination of software, firmware, and/or hardware. Controller 110 is described in greater detail below with respect to FIG. 3.

In some examples, controller 110 is a computing device that is local or remote relative to scene 105 (e.g., a physical environment). For example, controller 110 is a local server located within scene 105. In another example, controller 110 is a remote server located outside of scene 105 (e.g., a cloud server, central server, etc.). In some examples, controller 110 is communicatively coupled with the component(s) of computer system 101 that are configured to provide output to the user (e.g., output devices 155 and/or user-facing component 120) via one or more wired or wireless communication channels (e.g., BLUETOOTH, IEEE 802.11x, IEEE 802.16x, IEEE 802.3x, etc.). In some examples, controller 110 is included within the enclosure (e.g., a physical housing) of the component(s) of computer system 101 that are configured to provide output to the user (e.g., user-facing component 120) or shares the same physical enclosure or support structure with the component(s) of computer system 101 that are configured to provide output to the user.

In some examples, the various components and functions of controller 110 described below with respect to FIGS. 3, 4, 5A-5L, 6A-6G, 7, and 8 are distributed across multiple devices. For example, a first set of the components of controller 110 (and their associated functions) are implemented on a server system remote to scene 105 while a second set of the components of controller 110 (and their associated functions) are local to scene 105. For example, the second set of components are implemented within a portable electronic device (e.g., a wearable device such as an HMD) that is present within scene 105. It will be appreciated that the particular manner in which the various components and functions of controller 110 are distributed across various devices can vary based on different implementations of the examples described herein.

FIG. 3 is a block diagram of a controller 110, according to some examples. While certain specific features are illustrated, those skilled in the art will appreciate from the present disclosure that various other features have not been illustrated for the sake of brevity, and so as not to obscure more pertinent aspects of the examples disclosed herein. Moreover, FIG. 3 is intended more as a functional description of the various features that may be present in a particular implementation, as opposed to a structural schematic of the examples described herein. As recognized by those of ordinary skill in the art, components shown separately could be combined and some components could be separated. For example, some functional modules shown separately in FIG. 3 could be implemented in a single module and the various functions of single functional blocks could be implemented by one or more functional blocks in various examples. The actual number of modules and the division of particular functions and how features are allocated among them will vary from one implementation to another and, in some examples, depends in part on the particular combination of hardware, software, and/or firmware chosen for a particular implementation.

In some examples, controller 110 includes one or more processing units 302 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 306, one or more communication interfaces 308 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 310, memory 320, and one or more communication buses 304 for interconnecting these and various other components.

In some examples, one or more communication buses 304 include circuitry that interconnects and controls communications between system components. In some examples, one or more I/O devices 306 include at least one of a keyboard, a mouse, a touchpad, a joystick, one or more microphones, one or more speakers, one or more image sensors, one or more displays, and/or the like.

Memory 320 includes high-speed random-access memory, such as dynamic random-access memory (DRAM), static random-access memory (SRAM), double-data-rate random-access memory (DDR RAM), or other random-access solid-state memory devices. In some examples, memory 320 includes non-volatile memory, such as one or more magnetic disk storage devices, optical disk storage devices, flash memory devices, or other non-volatile solid-state storage devices. Memory 320 optionally includes one or more storage devices remotely located from the one or more processing units 302. Memory 320 comprises a non-transitory computer-readable storage medium. In some examples, memory 320 or the non-transitory computer-readable storage medium of memory 320 stores the following programs, modules and data structures, or a subset thereof, including an optional operating system 330 and three-dimensional (3D) experience module 340.

Operating system 330 includes instructions for handling various basic system services and for performing hardware-dependent tasks.

In some examples, three-dimensional (3D) experience module 340 is configured to manage and coordinate the user experience provided by computer system 101 with respect to a three-dimensional scene. For example, 3D experience module 340 is configured to obtain data corresponding to the three-dimensional scene (e.g., data generated by computer system 101 and/or data from data obtaining unit 341 discussed below) to cause computer system 101 to perform actions for the user (e.g., provide suggestions, display content, etc.) based on the data. To that end, in various examples, 3D experience module 340 includes data obtaining unit 341, tracking unit 342, coordination unit 346, data transmission unit 348, digital assistant (DA) unit 350, and 3D sound unit 360.

In some examples, data obtaining unit 341 is configured to obtain data (e.g., presentation data, interaction data, sensor data, location data, etc.) from one or more of user-facing component 120, input devices 125, output devices 155, sensors 190, and peripheral devices 195. To that end, in various examples, data obtaining unit 341 includes instructions and/or logic therefor, and heuristics and metadata therefor.

In some examples, tracking unit 342 is configured to map scene 105 and to track the position/location of the user (and/or of a portable device being held or worn by the user). To that end, in various examples, tracking unit 342 includes instructions and/or logic therefor, and heuristics and metadata therefor.

In some examples, tracking unit 342 includes eye tracking unit 343. Eye tracking unit 343 includes instructions and/or logic for tracking the position and movement of the user's gaze (or more broadly, the user's eyes, face, or head) using data obtained from eye tracking device 130. In some examples, eye tracking unit 343 tracks the position and movement of the user's gaze relative to a physical environment, relative to the user (e.g., the user's hand, face, or head), relative to a device worn or held by the user, and/or relative to content displayed by user-facing component 120.

Eye tracking device 130 is controlled by eye tracking unit 343 and includes various hardware and/or software components configured to perform eye tracking techniques. For example, eye tracking device 130 includes at least one eye tracking camera (e.g., infrared (IR) or near-IR (NIR) cameras) and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards mirrors that reflect IR or NIR light from the eyes to the eye tracking cameras. Eye tracking device 130 optionally captures images of the user's eyes (e.g., as a video stream captured at 60-120 frames per second), analyzes the images to generate eye tracking information, and communicates the eye tracking information to eye tracking unit 343. In some examples, two eyes of the user are separately tracked by respective eye tracking cameras and illumination sources. In some examples, only one eye of the user is tracked by a respective eye tracking camera and illumination sources.

In some examples, tracking unit 342 includes hand tracking unit 344. Hand tracking unit 344 includes instructions and/or logic for tracking, using hand tracking data obtained from hand tracking device 140, the position of one or more portions of the user's hands and/or motions of one or more portions of the user's hands. Hand tracking unit 344 tracks the position and/or motion relative to scene 105, relative to the user (e.g., the user's head, face, or eyes), relative to a device worn or held by the user, relative to content displayed by user-facing component 120, and/or relative to a coordinate system defined relative to the user's hand. In some examples, hand tracking unit 344 analyzes the hand tracking data to identify a hand gesture (e.g., a pointing gesture, a pinching gesture, a clenching gesture, and/or a grabbing gesture) and/or to identify content (e.g., physical content or virtual content) corresponding to the hand gesture, e.g., content selected by the hand gesture. In some examples, a hand gesture is an air gesture. An air gesture is a gesture that is detected without the user touching (or independently of) an input element that is part of a device (e.g., computer system 101, one or more input devices 125, hand tracking device 140, and/or device 500) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

Hand tracking device 140 is controlled by hand tracking unit 344 and includes various hardware and/or software components configured to perform hand tracking and hand gesture recognition techniques. For example, hand tracking device 140 includes one or more image sensors (e.g., one or more IR cameras, 3D cameras, depth cameras, and/or color cameras, etc.) that capture three-dimensional information (e.g., a depth map) that represents a hand of a human user. The one or more image sensors capture the hand images with sufficient resolution to distinguish the fingers and their respective positions. In some examples, the one or more image sensors project a pattern of spots onto an environment that includes the hand and capture an image of the projected pattern. In some examples, the one or more image sensors capture a temporal sequence of the hand tracking data (e.g., captured three-dimensional information and/or captured images of the projected pattern) and hand tracking device 140 communicates the temporal sequence of the hand tracking data to hand tracking unit 344 for further analysis, e.g., to identify hand gestures, hand poses, and/or hand movements.

In some examples, hand tracking device 140 includes one or more hardware input devices configured to be worn and/or held by (or be otherwise attached to) one or more respective hands of the user. In such examples, hand tracking unit 344 tracks the position, pose, and/or motion of a user's hand based on tracking the position, pose, and/or motion of the respective hardware input device. Hand tracking unit 344 tracks the position, pose, and/or motion of the respective hardware input device optically (e.g., via one or more image sensors) and/or based on data obtained from sensor(s) (e.g., accelerometer(s), magnetometer(s), gyroscope(s), inertial measurement unit(s), and the like) contained within the hardware input device. In some examples, the hardware input device includes one or more physical controls (e.g., button(s), touch-sensitive surface(s), pressure-sensitive surface(s), knob(s), joystick(s), and the like). In some examples, instead of, or in addition to, performing a particular function in response to detecting a respective type of hand gesture, computer system 101 analogously performs the particular function in response to a user input that selects a respective physical control of the hardware input device. For example, computer system 101 interprets a pinching hand gesture input as a selection of an in-focus element and/or interprets selection of a physical button of the hardware device as a selection of the in-focus element.

In some examples, coordination unit 346 is configured to manage and coordinate the experience provided to the user via user-facing component 120, one or more output devices 155, and/or one or more peripheral devices 195. To that end, in various examples, coordination unit 346 includes instructions and/or logic therefor, and heuristics and metadata therefor.

In some examples, data transmission unit 348 is configured to transmit data (e.g., presentation data, location data, etc.) to user-facing component 120, one or more input devices 125, output devices 155, sensors 190, and/or peripheral devices 195. To that end, in various examples, data transmission unit 348 includes instructions and/or logic therefor, and heuristics and metadata therefor.

Digital assistant (DA) unit 350 includes instructions and/or logic for providing DA functionality to computer system 101. DA unit 350 therefore provides a user of computer system 101 with DA functionality while they and/or their avatar are present in a three-dimensional scene. For example, the DA performs various tasks related to the three-dimensional scene, either proactively or upon request from the user.

DA unit 350 is configured to determine a user intent based on data from data obtaining unit 341. In some examples, DA unit 350 determines a user intent based on natural language input. To that end, DA unit 350 includes speech-to-text (STT) processing unit 352 and natural language processing (NLP) unit 351. STT processing unit 352 is configured to perform speech recognition (if the natural language input is received in audio format) and natural language processing unit 351 is configured to determine the user intent based on speech recognition results obtained by STT processing unit 352.

In some examples, DA unit 350 is configured to determine a user intent based on image data, e.g., a single image or a series of images. In some examples, DA unit 350 determines the user intent by processing the image data and without processing natural language input. For example, based on image data that depicts a user repeatedly turning a loose doorknob, DA unit 350 infers a user intent of obtaining assistance with fixing the doorknob.

In some examples, DA unit 350 is configured to determine a user intent based on a combination of image data and natural language input. For example, DA unit 350 uses the image data to resolve (e.g., disambiguate) a natural language reference to an entity, or otherwise uses the image data to refine a user intent determined from the natural language input. For example, based on the natural language input “tell me about these sodas” and image data that depicts “soda brand #1” and “soda brand #2” in a user's field of view, DA unit 350 determines the user intent of obtaining information about “soda brand #1” and “soda brand #2.”

In some examples, DA unit 350 includes object recognition unit 353. Object recognition unit 353 is configured to perform object recognition techniques to recognize (e.g., identify) objects that are present in a 3D scene. In some examples, object recognition unit 353 is configured to identify the positions and/or directions of the objects. Object recognition unit 353 identifies the positions and/or directions of the objects relative to a fixed coordinate system that is defined relative to the 3D scene and/or relative to the position of the user device (e.g., device 500 in FIGS. 5A-5L and FIGS. 6A-6G) being used to interact with the 3D scene. In some examples, object recognition unit 353 is configured to determine the distance between an object and the user device.

In some examples, DA unit 350 determines different types of user intents. The different types of intents include a first type of intent (e.g., a multi-object intent), a second type of intent (e.g., a default intent), and a third type of intent (e.g., a single object intent). A user intent is a multi-object intent when the user intent corresponds to multiple objects within a 3D scene associated with the user. For example, a user intent is a multi-object intent when DA unit 350 determines, based on the user intent, the respective positions (and/or directions) of multiple objects in the 3D scene. As a specific example, a user intent corresponding to “tell me about these sodas” is a multi-object intent when DA unit 350 identifies the respective positions of multiple bottles of soda within the 3D scene. A user intent is a default intent when the user intent does not correspond to an object (e.g., any object) within the 3D scene. For example, a user intent is a default intent when DA unit 350 does not determine, based on the user intent, the position (or direction) of any object in the 3D scene. As a specific example, a user intent to obtain weather information is a default intent when DA unit 350 does not determine the position of any object (e.g., a weather application icon) based on the user intent. A user intent is a single object intent when the user intent corresponds to a single object within the 3D scene. For example, a user intent is a single object intent when DA unit 350 determines, based on the user intent, the position (and/or direction) of a single object within the 3D scene. As a specific example, a user intent to obtain information about a particular object is a single object intent when DA unit 350 identifies the position of the particular object and does not identify the position of any other object within the 3D scene. As discussed below with respect to FIGS. 5A-5L, the user device can output different types of spoken responses that respectively depend on the type of the user intent.

In conjunction with 3D sound unit 360, DA unit 350 is configured to generate spoken responses based on the user intent, the type of the user intent, and/or object data from object recognition unit 353. The spoken responses may assist the user with fulfilling various user intents. In some examples, DA unit 350 generates executable instructions, that when executed by the user device, cause the user device to output the spoken responses.

3D sound unit 360 is configured to apply 3D audio processing techniques to audio data. For example, 3D sound unit 360 applies 3D audio effects such that a sound virtually emanates from a position within a 3D scene associated with the user. A sound virtually emanates from a particular position within the 3D scene when a listener perceives the sound to emanate from the particular position, despite that the sound output device(s) (e.g., one or more speakers) may not be physically positioned at the particular position. In some examples, 3D sound unit 360 is configured to apply 3D audio effects such that a sound has a particular virtual direction. A sound has a particular virtual direction when a listener perceives the sound to originate from the particular virtual direction (e.g., in front of the listener, behind the listener, to the left of the listener, to the right of the listener, above the listener, or below the listener), despite that the sound output device(s) may not be physically positioned in the particular direction relative to the listener. In some examples, 3D sound unit 360 is configured to apply 3D audio effects such that a sound appears to virtually move in a particular direction and/or virtually cease at a particular position. For example, 3D sound unit 360 is configured to generate a sound that is perceived by a listener to move in a particular direction and then cease (e.g., be absorbed) at a particular end position, such that the end position is perceived to be a sound absorption element. In some examples, 3D sound unit 306 is configured to adjust various sound characteristics (e.g., tone, pitch, volume, emotion, etc.) that affect how a listener perceives output sound. For example, 3D sound unit 360 is configured to generate sounds with characteristics of happy, sad, angry, underwater, muffled, robotic, and/or metallic.

In some examples, 3D experience module 340 accesses one or more artificial intelligence (AI) models that are configured to perform various functions described herein. The AI model(s) are at least partially implemented on controller 110 (e.g., implemented locally on a single device, or implemented in a distributed manner) and/or controller 110 communicates with one or more external services that provide access to the AI model(s). In some examples, one or more components and functions of DA unit 350 and/or 3D sound unit 360 are implemented using the AI model(s). For example, DA unit 350 implements one or more AI models to perform speech recognition, intent determination (e.g., natural language processing and/or image processing), object recognition, and/or response generation and 3D sound unit 360 implements one or more AI models to generate sounds with the above-described 3D effects.

In some examples, the AI model(s) are based on (e.g., are, or are constructed from) one or more foundation models. Generally, a foundation model is a deep learning neural network that is trained based on a large training dataset and that can adapt to perform a specific function. Accordingly, a foundation model aggregates information learned from a large (and optionally, multimodal) dataset and can adapt to (e.g., be fine-tuned to) perform various downstream tasks that the foundation model may not have been originally designed to perform. Examples of such tasks include language translation, speech recognition, user intent determination (e.g., natural language processing), sentiment analysis, computer vision tasks (e.g., object recognition and scene understanding), question answering, image generation, audio generation, and generation of computer-executable instructions. Foundation models can accept a single type of input (e.g., text data) or accept multimodal input, such as two or more of text data, image data, video data, audio data, sensor data, and the like. In some examples, a foundation model is prompted to perform a particular task by providing it with a natural language description of the task. Example foundation models include the GPT-n series of models (e.g., GPT-1, GPT-2, GPT-3, and GPT-4), DALL-E, and CLIP from Open AI, Inc., Florence and Florence-2 from Microsoft Corporation, BERT from Google LLC, and LLAMA, LLAMA-2, and LLAMA-3 from Meta Platforms, Inc.

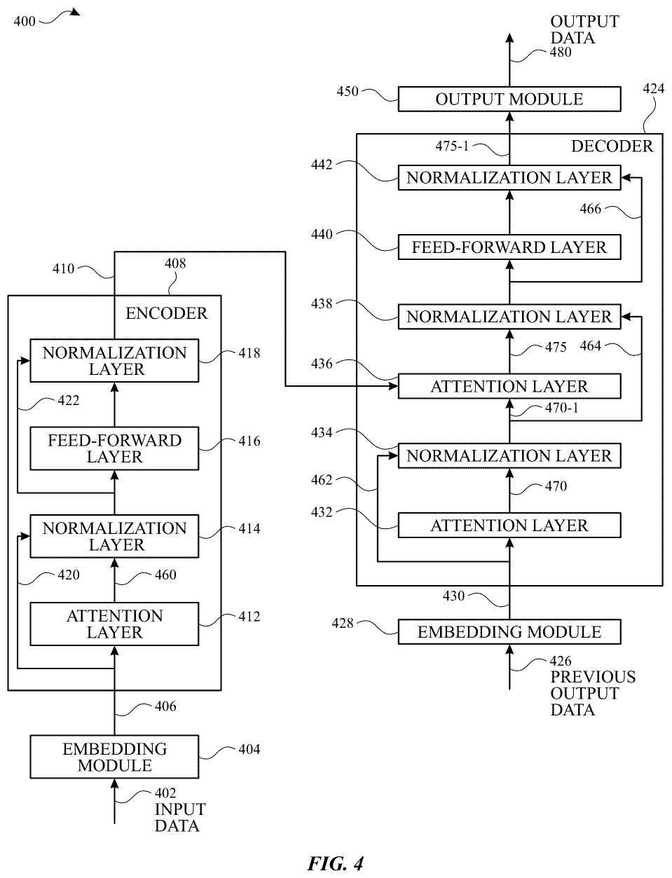

FIG. 4 illustrates architecture 400 for a foundation model, according to some examples. Architecture 400 is merely exemplary and various modifications to architecture 400 are possible. Accordingly, the components of architecture 400 (and their associated functions) can be combined, the order of the components (and their associated functions) can be changed, components of architecture 400 can be removed, and other components can be added to architecture 400. Further, while architecture 400 is transformer-based, one of skill in the art will understand that architecture 400 can additionally or alternatively implement other types of machine learning models, such as convolutional neural network (CNN)-based models and recurrent neural network (RNN)-based models.

Architecture 400 is configured to process input data 402 to generate output data 480 that corresponds to a desired task. Input data 402 includes one or more types of data, e.g., text data, image data, video data, audio data, sensor (e.g., motion sensor, biometric sensor, temperature sensor, and the like) data, computer-executable instructions, structured data (e.g., in the form of an XML file, a JSON file, or another file type), and the like. In some examples, input data 402 includes data from data obtaining unit 341. Output data 480 includes one or more types of data that depend on the task to be performed. For example, output data 480 includes one or more of: text data, image data, audio data, and computer-executable instructions. It will be appreciated that the above-described input and output data types are merely exemplary and that architecture 400 can be configured to accept various types of data as input and generate various types of data as output. Such data types can vary based on the particular function the foundation model is configured to perform.

Architecture 400 includes embedding module 404, encoder 408, embedding module 428, decoder 424, and output module 450, the functions of which are now discussed below.

Embedding module 404 is configured to accept input data 402 and parse input data 402 into one or more token sequences. Embedding module 404 is further configured to determine an embedding (e.g., a vector representation) of each token that represents each token in embedding space, e.g., so that similar tokens have a closer distance in embedding space and dissimilar tokens have a further distance. In some examples, embedding module 404 includes a positional encoder configured to encode positional information into the embeddings. The respective positional information for an embedding indicates the embedding's relative position in the sequence. Embedding module 404 is configured to output embedding data 406 of the input data by aggregating the embeddings for the tokens of input data 402.

Encoder 408 is configured to map embedding data 406 into encoder representation 410. Encoder representation 410 represents contextual information for each token that indicates learned information about how each token relates to (e.g., attends to) each other token. Encoder 408 includes attention layer 412, feed-forward layer 416, normalization layers 414 and 418, and residual connections 420 and 422. In some examples, attention layer 412 applies a self-attention mechanism on embedding data 406 to calculate an attention representation (e.g., in the form of a matrix) of the relationship of each token to each other token in the sequence. In some examples, attention layer 412 is multi-headed to calculate multiple different attention representations of the relationship of each token to each other token, where each different representation indicates a different learned property of the token sequence. Attention layer 412 is configured to aggregate the attention representations to output attention data 460 indicating the cross-relationships between the tokens from input data 402. In some examples, attention layer 412 further masks attention data 460 to suppress data representing the relationships between select tokens. Encoder 408 then passes (optionally masked) attention data 460 through normalization layer 414, feed-forward layer 416, and normalization layer 418 to generate encoder representation 410. Residual connections 420 and 422 can help stabilize and shorten the training and/or inference process by respectively allowing the output of embedding module 404 (i.e., embedding data 406) to directly pass to normalization layer 414 and allowing the output of normalization layer 414 to directly pass to normalization layer 418.

While FIG. 4 illustrates that architecture 400 includes a single encoder 408, in other examples, architecture 400 includes multiple stacked encoders configured to output encoder representation 410. Each of the stacked encoders can generate different attention data, which may allow architecture 400 to learn different types of cross-relationships between the tokens and generate output data 410 based on a more complete set of learned relationships.

Decoder 424 is configured to accept encoder representation 410 and previous output embedding 430 as input to generate output data 480. Embedding module 428 is configured to generate previous output embedding 430. Embedding module 428 is similar to embedding module 404. Specifically, embedding module 428 tokenizes previous output data 426 (e.g., output data 480 that was generated by the previous iteration), determines embeddings for each token, and optionally encodes positional information into each embedding to generate previous output embedding 430.

Decoder 424 includes attention layers 432 and 436, normalization layers 434, 438, and 442, feed-forward layer 440, and residual connections 462, 464, and 466. Attention layer 432 is configured to output attention data 470 indicating the cross-relationships between the tokens from previous output data 426. Attention layer 432 is similar to attention layer 412. For example, attention layer 432 applies a multi-headed self-attention mechanism on previous output embedding 430 and optionally masks attention data 470 to suppress data representing the relationships between select tokens (e.g., the relationship(s) between a token and future token(s)) so architecture 400 does not consider future tokens as context when generating output data 480. Decoder 424 then passes (optionally masked) attention data 470 through normalization layer 434 to generate normalized attention data 470-1.

Attention layer 436 accepts encoder representation 410 and normalized attention data 470-1 as input to generate encoder-decoder attention data 475. Encoder-decoder attention data 475 correlates input data 402 to previous output data 426 by representing the relationship between the output of encoder 408 and the previous output of decoder 424. Attention layer 436 allows decoder 424 to increase the weight of the portions of encoder representation 410 that are learned as more relevant to generating output data 480. In some examples, attention layer 436 applies a multi-headed attention mechanism to encoder representation 410 and to normalized attention data 470-1 to generate encoder-decoder attention data 475. In some examples, attention layer 436 further masks encoder-decoder attention data 475 to suppress the cross-relationships between select tokens.

Decoder 424 then passes (optionally masked) encoder-decoder attention data 475 through normalization layer 438, feed-forward layer 440, and normalization layer 442 to generate further-processed encoder-decoder attention data 475-1. Normalization layer 442 then provides further-processed encoder-decoder attention data 475-1 to output module 450. Similar to residual connections 420 and 422, residual connections 462, 464, and 466 may stabilize and shorten the training and/or inference process by allowing the output of a corresponding component to directly pass as input to a corresponding component.

While FIG. 4 illustrates that architecture 400 includes a single decoder 424, in other examples, architecture 400 includes multiple stacked decoders each configured to learn/generate different types of encoder-decoder attention data 475. This allows architecture 400 to learn different types of cross-relationships between the tokens from input data 402 and the tokens from output data 480, which may allow architecture 400 to generate output data 480 based on a more complete set of learned relationships.

Output module 450 is configured to generate output data 480 from further-processed encoder-decoder attention data 475-1. For example, output module 450 includes one or more linear layers that apply a learned linear transformation to further-processed encoder-decoder attention data 475-1 and a softmax layer that generates a probability distribution over the possible classes (e.g., words or symbols) of the output tokens based on the linear transformation data. Output module 450 then selects (e.g., predicts) an element of output data 480 based on the probability distribution. Architecture 400 then passes output data 480 as previous input data 426 to embedding module 428 to begin another iteration of the training and/or inference process for architecture 400.

It will be appreciated that various different AI models can be constructed based on the components of architecture 400. For example, some large language models (LLMs) (e.g., GPT-2 and GPT-3) are decoder-only (e.g., include one or more instances of decoder 424 and do not include encoder 408), some LLMs (e.g., BERT) are encoder-only (include one or more instances of encoder 408 and do not include decoder 424), and other foundation models (e.g., Florence-2) are encoder-decoder (e.g., include one or more instances of encoder 408 and include one or more instances of decoder 424). Further, it will be appreciated that the foundation models constructed based on the components of architecture 400 can be fine-tuned based on reinforcement learning techniques and training data specific to a particular task for optimization for the particular task, e.g., extracting relevant semantic information from image and/or video data, generating code, generating music, providing suggestions relevant to a specific user, and the like.

FIGS. 5A-5L and 6A-6G illustrate spoken responses that are provided by using 3D audio effects, according to some examples.

The left panels of FIGS. 5A-5L and 6A-6G illustrate a user's view of respective 3D scenes. In some examples, device 500 provides at least a portion of the scenes of FIGS. 5A-5L and 6A-6G. For example, the scenes are XR scenes that include at least some virtual elements generated by device 500. In other examples, the scenes are physical scenes.

The right panels of FIGS. 5A-5L and 6A-6G illustrate respective top-down views of the 3D scenes. The top-down views illustrate the position of device 500, the position of various objects within the 3D scene, and/or the positions from which spoken responses virtually emanate. The top-down views further illustrate various directions. The directions are for illustrative purpose only and are not part of the respective 3D scenes. In some examples, the user wears, holds, or otherwise physically contacts device 500, so the positions of device 500 in FIGS. 5A-5L and 6A-6G approximate the position of the user.

Device 500 implements at least some of the components of computer system 101. For example, device 500 includes one or more sensors configured to detect data (e.g., image data and/or audio data) corresponding to the respective scenes. In some examples, device 500 is an HMD (e.g., an XR headset or smart glasses) and FIGS. 5A-5L and 6A-6G illustrate the user's view of the respective scenes via the HMD. For example, 5A-5L and 6A-6G illustrate physical scenes viewed via pass-through video, physical scenes viewed via direct optical see-through, or virtual scenes viewed via one or more displays of the HMD. In other examples, device 500 is another type of device, such as a smart watch, a smart phone, a tablet device, a laptop computer, a projection-based device, or a pair of headphones or earbuds.

The examples of FIGS. 5A-5L and 6A-6G illustrate that the user and device 500 are present within the respective scenes. For example, the scenes are physical or extended reality scenes and the user and device 500 are physically present within the scenes. In other examples, an avatar of the user is present within the scenes. For example, when the scenes are virtual reality scenes, the avatar of the user is present within the virtual reality scenes.

In FIG. 5A, the scene includes the user, soda bottle 510, and soda bottle 512. Device 500 is at position 502, soda bottle 510 is at position 506, and soda bottle 512 is at position 508. Soda bottles 510 and 512 are in the user's field of view. Direction 504 indicates a front-facing direction of device 500 (e.g., of a user who wears, holds, or otherwise interacts with device 500).

In FIG. 5A, device 500 receives the user's speech input 511 “tell me about this soda.” Device 500 further captures image data that depicts soda bottles 510 and 512. Based on speech input 511 and the image data, a DA (e.g., DA unit 350) determines a user intent of obtaining information about a single soda bottle. Further, the DA identifies soda bottles 510 and 512 as separate candidate soda bottles for the user intent. The DA further identifies positions 506 and 508 of soda bottles 510 and 512. Accordingly, in FIGS. 5A-5C, the user intent is a multi-object intent.

In FIGS. 5B-5C, to satisfy the user intent, device 500 outputs spoken response 514. Spoken response 514 corresponds to a request for user disambiguation between soda bottle 510 and soda bottle 512. As illustrated, device 500 outputs spoken response 514 by first audibly outputting portion 514-1 of spoken response 514 (in FIG. 5B) and by then audibly outputting portion 514-2 of spoken response 514 (in FIG. 5C).

In FIG. 5B, device 500 displays DA virtual object 516 at position 518 while device 500 audibly outputs portion 514-1 (“this one?”). In FIG. 5C, device 500 displays digital assistant virtual object 516 at position 520 while device 500 audibly outputs portion 514-2 (“or this one?”). Accordingly, digital assistant virtual object 516 moves between corresponding objects while providing different portions of response 514. In this manner, device 500 may help direct the user's attention to the particular object that is relevant to the current spoken output.

In FIGS. 5B-5C, the audible outputs of portion 514-1 and portion 514-2 virtually emanate from different positions that are respectively based on soda bottle 510 and soda bottle 512. Specifically, portion 514-1 virtually emanates from position 518 of digital assistant virtual object 516 and portion 514-2 virtually emanates from position 520 of digital assistant virtual object 516. Position 518 is selected to be within a predetermined distance (e.g., 0.5 meters, 0.25 meters, 0.1 meters, or 0.05 meters) from position 506 of soda bottle 510. Similarly, position 520 is selected to be within the predetermined distance from position 508 of soda bottle 512. Accordingly, the audio output of a spoken response that is relevant to a particular object can virtually emanate from a position that is within a relatively close distance to the position of the particular object.

While FIGS. 5B-5C illustrate that device 500 audibly outputs portions 514-1 and 514-2 such that they respectively virtually emanate from positions 518 and 520 of digital assistant virtual object 516, in other examples, device 500 audibly outputs portions 514-1 and 514-2 such that they respectively virtually emanate from positions 506 and 508 of corresponding soda bottles 510 and 512. In some examples, while audibly outputting portion 514-1, device 500 displays DA virtual object 516 at position 518. And while audibly outputting portion 514-2, device 500 displays DA virtual object 516 at position 520. Accordingly, in some examples, when a spoken response virtually emanates from the position of a corresponding object, the display of DA virtual object 516 is offset (e.g., by less than the predetermined distance) from the position of the corresponding object.

In FIGS. 5B-5C, the audible outputs of portions 514-1 and 514-2 have respective directions 522 and 524 relative to device 500. Direction 522 corresponds to direction 526 of soda bottle 510 relative to device 500. Similarly, direction 524 corresponds to direction 528 of soda bottle 512 relative to device. For example, in FIG. 5B, direction 522 has less than a predetermined angular deviation (e.g., 5°, 10°, or 15°) from direction 526, e.g., as defined by the value of angle θ₁ between directions 522 and 526. In other examples, direction 522 is direction 526. Similarly, in FIG. 5C, direction 524 has less than a predetermined angular deviation (e.g., 5°, 10°, or 15°) from direction 528, e.g., as defined by the value of angle θ₂ between directions 524 and 528. In other examples, direction 524 is direction 528.

Accordingly, FIGS. 5B-5C (and similarly below FIGS. 5D-5I) illustrate that the virtual positions and/or directions of a spoken response can move to indicate the positions (e.g., locations) of relevant objects. In this manner, device 500 may further help direct the user's attention towards objects that are relevant to the user intent.

In some examples, device 500 outputs a spoken response (e.g., 514) that virtually emanates from a source position (e.g., 518 and/or 520) that is based on an object position (e.g., 506 and/or 508) if the object is within a threshold distance of device 500. For example, in FIGS. 5B-5C, device 500 provides spoken response 514 that virtually emanates from positions 518 and 520 because soda bottle 510 and soda bottle 512 are each within the threshold distance (e.g., 10 meters, 5 meters, 3 meters, or 1 meter) from device 500. In some examples, if an object is not within the threshold distance of device 500, device 500 does not provide a corresponding spoken response that virtually emanates from a source position that is based on the object's position. Instead, device 500 provides the corresponding response such that it emanates from a default position, e.g., as described below with respect to FIGS. 5J-5K. In this manner, device 500 may accurately and efficiently direct a user's attention towards relatively close objects. Device 500 may further save battery and processing power by forgoing additional audio processing to attempt to direct a user's attention towards relatively far objects, as it is less likely that an audio output can sufficiently direct a user's attention to a far-away object.

FIGS. 5D-5G illustrate another example of spoken responses that are provided by using 3D audio effects. In FIG. 5D, the scene includes the user, doorknob 530, hex key 532, and screwdriver 534. The left panel of FIG. 5D illustrates that doorknob 530 and hex key 532 are in front of (e.g., in the field of view of) the user (as further illustrated by front-facing direction 504) and that screwdriver 534 is behind (e.g., not in the field of view of) the user. In examples where device 500 includes one or more front-facing image sensors, in FIG. 5D, doorknob 530 and hex key 532 are in the field of view of the front-facing image sensor(s) and screwdriver 534 is not in the field of view of the front-facing image sensor(s).

In the scene of FIG. 5D, the user repeatedly turns loose doorknob 530. Device 500 captures image data (e.g., via the front-facing image sensor(s)) that represents the scene of FIG. 5D. Based on the image data, and without receiving any natural language input, the DA proactively determines a user intent of fixing a loose doorknob. Based on the user intent, the DA generates a response to assist the user with locating hex key 532 and screwdriver 534 to tighten loose doorknob 530. The DA further identifies position 536 of hex key 532 and identifies position 538 of screwdriver 534. Accordingly, in FIGS. 5D-5G, the user intent is a multi-object intent.

In FIGS. 5E-5G, device 500 audibly outputs spoken response 540 to assist the user with fixing their loose doorknob. Specifically, in FIG. 5E, device 500 audibly outputs portion 540-1 (“your screwdriver . . . ”) of spoken response 540. Portion 540-1 virtually emanates from position 542 that is based on (e.g., that is or that is within a predetermined distance of) position 538 of screwdriver. Portion 540-1 has direction 544 that corresponds to (e.g., that is or that has less than a predetermined angular deviation from) direction 546 of screwdriver 534 relative to device 500.

In FIGS. 5E-5F, while device 500 audibly outputs portion 540-1, device 500 detects a change in pose (e.g., position and/or orientation) of the user. Specifically, in FIG. 5F, the user has turned to face position 542 of portion 540-1, as indicated by front-facing direction 504. In response to detecting the change in pose, device 500 continues to audibly output portion 540-1 (“ . . . is right here”). The continued audible output of portion 540-1 continues to virtually emanate from position 542. The continued audible output of portion 540-1 also has the same direction 544, e.g., as defined relative to a fixed coordinate system.

In FIG. 5F, after device 500 audibly outputs portion 540-1 of spoken response 540, device 500 audibly outputs portion 540-2 (“and your hex key . . . ”) of spoken response 540. Portion 540-2 virtually emanates from position 548 that is based on position 536 of hex key 532. Portion 540-2 also has direction 550 that corresponds to direction 552 of hex key 532 relative to device 500.

In FIGS. 5F-5G, while device 500 audibly outputs portion 540-2, device 500 detects another change in pose of the user. Specifically, in FIG. 5G, the user has turned around to face position 548 of portion 540-2, as indicated by front-facing direction 504. Similar to FIGS. 5E-5F, in response to detecting the change in pose, device 500 continues to audibly output portion 540-2 (“ . . . is right here”). The continued audible output of portion 540-2 continues to virtually emanate from position 548. The continued audible output of portion 540-2 also has the same direction 550, e.g., as defined relative to a fixed coordinate system. Accordingly, FIGS. 5E-5G illustrate that as the user changes pose within a 3D scene, the virtual position and/or direction of a spoken response can remain fixed to the position of a corresponding object. In this manner, device 500 can continue to direct a user's attention towards relevant objects even as the user moves about the 3D scene.

FIGS. 5H-5I illustrate another example of spoken responses that are provided by using 3D audio effects. In FIG. 5H, the scene includes front door 554 and keys 556. The left panel of FIG. 5H illustrates that front door 554 is in front of the user (as further indicated by front-facing direction 504) and that keys 556 are behind the user. In examples where device 500 includes one or more front-facing image sensors, in FIG. 5H, front door 554 is in the field of view of the front-facing image sensor(s) and keys 556 are not in the field of view of the front-facing image sensor(s).

In FIG. 5H, device 500 receives the user's speech input 558 (“where are my keys?”). Based on speech input 558, the DA determines a user intent of finding their keys. Further, based on the user intent, the DA identifies position 560 of keys 556 and does not identify the position of any other object within the 3D scene. Accordingly, in FIGS. 5H-5I, the user intent is a single-object intent.

In FIG. 5I, device 500 audibly outputs spoken response 562 to assist the user with finding their keys. Spoken response 562 virtually emanates from position 564 that is based on (e.g., that is or that is within a predetermined distance of) position 560 of keys 556. Spoken response 562 also has direction 566 that corresponds to (e.g., that is or that has less than a predetermined angular deviation from) direction 568 of keys 556 relative to device 500.

In some examples, similar to that described above with respect to FIGS. 5A-5C, device 500 audibly outputs spoken response 562 that virtually emanates from position 564 if position 560 of keys 556 is within a threshold distance of device 500. If position 560 is not within the threshold distance (e.g., keys 556 are too far away), device 500 can audibly output a spoken response that emanates from a default position, as now described below with respect to FIGS. 5J-5K.

FIGS. 5J-5K illustrate another example of spoken responses that are provided by using 3D audio effects. In FIG. 5J, the scene includes the user and table 570 in front of the user. In FIG. 5J, device 500 receives the user's speech input 572 (“what's the weather today?”) Based on speech input 572, the DA determines a user intent of obtaining weather information. The DA does not identify the position of any object based on the user intent (e.g., as the 3D scene does not include any objects relevant to obtaining weather information). Accordingly, in FIGS. 5J-5K, the user intent is a default intent.

In FIG. 5K, device 500 audibly outputs spoken response 574 (“it is 90 degrees and sunny outside”) to satisfy the user's intent. Spoken response 574 virtually emanates from default position 576. Default position 576 is within a predetermined distance (e.g., 0.1 meters, 0.3 meters, 0.5 meters, or 1 meter) away from device 500 and has a predetermined direction 578 relative to device 500. In some examples, as illustrated in FIG. 5K, predetermined direction 578 is defined by a predetermined amount (e.g., 0°, 5°, 10°, or 15°) of angular deviation (as defined by angle α) from front-facing direction 504. Accordingly, in examples where the DA does not identify the position of any object in the 3D scene that corresponds to a user intent, device 500 can respond to the user's request with a spoken response that emanates from a default position.

While the example of FIG. 5K illustrates that device 500 applies 3D audio effects for spoken response 574 to virtually emanate from default position 576, in other examples, device 500 does not apply any 3D audio effects for spoken response 574 to emanate from a default position. For example, the default position is the physical position (e.g., in the user's ear or next to the user's ear) of the one or more output devices (e.g., speakers) that output spoken response 574.

In contrast to FIGS. 5A-5C, FIGS. 5D-5K illustrate that device 500 does not display any virtual object (e.g., DA virtual object 516) while outputting spoken responses. For example, in FIGS. 5D-5K, device 500 does not include any display capable of presenting XR content (e.g., XR displays 212) (or more generally, does not include any display) and device 500 provides output via auditory and/or haptic means.

FIG. 5L illustrates a 3D audio effect that is provided in response to detecting an air gesture, according to various examples. In the scene of FIG. 5L, device 500 detects air gesture 580 (e.g., a pointing air gesture) that selects (e.g., points at) object 582. In response to detecting air gesture 580, device 500 audibly outputs sound effect 584. Sound effect 584 virtually originates from position 586 of air gesture 580 (e.g., the position in the 3D scene at which air gesture 580 is detected and/or performed). Sound effect 584 also virtually moves in direction 588 of object 582 relative to device 500, e.g., moves towards object 582. In some examples, sound effect 584 virtually ceases at the position of object 582, e.g., such that the position of object 582 is perceived to include a sound absorption element.

In some examples, a sound characteristic of sound effect 584 is based on an object characteristic of object 582 (e.g., color of the object, type of the object, material(s) the object is made of, location of the object, size of the object, environmental characteristics of the environment surrounding the object, and the like). The sound characteristic describes how sound effect 584 is perceived by a listener, e.g., the user of device 500. As one example, if object 582 is a metallic object, sound effect 584 has a “metallic” characteristic so sound effect 584 sounds metallic to a listener. As another example, if object 582 is underwater, sound effect 584 has an “underwater” characteristic so sound effect 584 sounds like it travels underwater.

Outputting sound effect 584 in response to detection of air gesture 580 provides the user with improved feedback that device 500 correctly interprets air gesture 580 as a selection of the correct object. Providing such improved feedback helps make the user-device interface more efficient and accurate, e.g., by avoiding repeated-user inputs and reducing the number of user inputs required to interact with device 500.

FIGS. 6A-6G illustrate spoken responses that are provided by using 3D audio effects.

In FIG. 6A, the scene includes the user, tea 602, and tea 604. Tea 602 is at position 606 and tea 604 is at position 608. In FIG. 6A, device 500 receives the user's speech input 610 “tell me about this tea.” Device 500 further captures image data that depicts tea 602 and tea 604. Based on speech input 610 and the image data, the DA determines the user intent of obtaining information about one of teas 602 or 604. The DA further determines teas 602 and 604 as different candidate teas for which the user would like information about.

In FIG. 6B, device 500 provides spoken response 612 to disambiguate the user's intent. Device 500 provides spoken response 612 by first audibly outputting portion 612-1 (“did you mean this one over here?”) of spoken response 612 and by then audibly outputting portion 612-2 (“or this one over there?”) of spoken response 612. Device 500 audibly outputs spoken response 612 without receiving any natural language input further to speech input 610.

In FIG. 6B, portion 612-1 virtually emanates from position 614 and portion 612-2 virtually emanates from position 616. Position 614 is based on tea 602 and position 616 is based on tea 604. For example, position 614 is determined based on position 606 of tea 602, position 614 is determined based on direction 622 of tea 602 relative to device 500, and/or position 614 is within a predetermined distance from position 606 of tea 602 (and similarly for position 616 with respect to tea 604).

In FIG. 6B, distance 620 between position 614 and position 616 (the positions from which spoken response 612 virtually emanates) is greater than distance 618 between position 606 and 608 (the positions of corresponding teas 602 and 604). Further, in FIG. 6B, tea 602 has direction 622 relative to device 500, portion 612-1 has direction 624 relative to device 500, tea 604 has direction 626 relative to device 500, and portion 612-2 has direction 628 relative to device 500. In the illustrated example, directions 622, 624, 626, and 628 are respectively defined by angular deviations θ₁, θ₂, θ₃, and θ₄ relative to front-facing direction 601 of device 500 (e.g., of a user who wears, holds, or otherwise interacts with device 500), but it will be appreciated that other ways of defining directions 622, 624, 626, and 628 are possible. The difference between directions 624 and 628 (e.g., as defined by |θ₁-θ₄|) of spoken response 612 is greater than the difference between directions 622 and 626 of corresponding teas 602 and 604 (e.g., as defined by |θ₂-θ₃|) Specifically, direction 624 (e.g., as defined by θ₂) is set to be more leftwards than direction 622 (e.g., as defined by θ₁) and direction 628 (e.g., as defined by θ₄) is set to be more rightwards than direction 626 (e.g., as defined by θ₃). In this manner, the user perceives portion 612-1 (“did you mean this one over here?) to virtually emanate from farther to the left than the actual position of tea 602. Similarly, the user perceives portion 612-2 (“or this one over there?”) to virtually emanate from farther to the right than the actual position of tea 604.

Accordingly, the user perceives spoken response 612 to emanate from positions and/or directions that are farther apart in space than the actual distance and/or directions between corresponding teas 602 and 604. For this reason, spoken response 612 (and similarly spoken responses 640 and 680 in FIGS. 6D, 6F, and 6G below) is sometimes referred to herein as a spatially exaggerated spoken response.

FIGS. 6C-6D illustrate another example of spoken responses that are provided using 3D audio effects. In FIG. 6C, the scene includes the user, tea 630, and tea 632. Tea 630 is at position 634 and tea 632 is at position 636. In FIG. 6D, device 500 receives the user's speech input 638 (“tell me about this tea”). Device 500 further captures image data that depicts tea 630 and tea 632. Based on speech input 638 and the image data, the DA determines the user intent of obtaining information about one of teas 630 or 632. The DA further determines teas 630 and tea 632 as different candidate teas for which the user would like information about.

In FIG. 6D, similar to FIG. 6B, device 500 provides spoken response 640 to disambiguate the user's intent. Device 500 provides spoken response 640 by first audibly outputting portion 640-1 (“did you mean this one over here?”) of spoken response 640 and by then audibly outputting portion 640-2 (“or this one over there?”) of spoken response 640.

In FIG. 6D, portion 640-1 virtually emanates from position 642 and portion 640-2 virtually emanates from position 644. Position 642 is based on tea 630 and position 644 is based on tea 632. In FIG. 6D, tea 630 has direction 650 relative to device 500, portion 640-1 has direction 652 relative to device 500, tea 632 has direction 654 relative to device 500, and portion 640-2 has direction 656 relative to device 500. Directions 650, 652, 654, and 656 are respectively defined by angular deviations α₁, α₂, α₃, and a relative to front-facing direction 601.

Similar to the example of FIGS. 6A-6B, in FIG. 6D, distance 646 between position 642 and position 644 (the positions from which spoken response 640 virtually emanates) is greater than is greater than distance 648 between positions 634 and 636 (the positions of corresponding teas 630 and 632). Also similar to the example of FIGS. 6A-6B, in FIG. 6D, the difference between directions 652 and 656 of spoken response 640 is greater than the difference between directions 650 and 654 of corresponding teas 630 and 632.

FIG. 6D illustrates that the amount by which a spoken response (e.g., 612 or 640) is spatially exaggerated is inversely related to the distance between the corresponding objects (e.g., 602 and 604 for spoken response 612 or 630 and 632 for spoken response 640). More specifically, in FIG. 6B, because teas 602 and 604 are relatively far apart, the distance between position 614 (from which portion 612-1 virtually emanates) and position 606 of tea 602 is relatively small (and similarly for the distance between position 616 and position 608 of tea 604). In contrast, in FIG. 6D, because teas 630 and 632 are relatively close together, the distance between position 642 (from which portion 640-1 virtually emanates) and position 634 of tea 630 is relatively large (and similarly for the distance between position 644 and position 636 of tea 632). Further, in FIG. 6B, because teas 602 and 604 are relatively far apart, the difference between direction 624 of portion 612-1 and direction 622 of tea 602 (e.g., |θ₁-θ₂|) is relatively small (and similarly for the difference between direction 628 of portion 612-1 and direction 626 of tea 604). In contrast, in FIG. 6D, because teas 630 and 632 are relatively close together, the difference between direction 652 of portion 640-1 and direction 650 of tea 630 (e.g., |α₁-α₂|) is relatively large (and similarly for the difference between direction 656 of portion 640-2 and direction 654 of tea 632).

As illustrated in FIGS. 6A-6D, outputting spatially exaggerated spoken responses 612 and 640 can help direct the user's attention towards relevant objects and help the user distinguish the currently in-focus object (e.g., teas 602, 604, 630, or 632) from other objects. Further, setting an inverse relationship between the amount by which a spoken response is spatially exaggerated and the distance between the corresponding objects may allow device 500 to intelligently determine an appropriate amount of spatial exaggeration. For example, if the objects are relatively close together (e.g., FIG. 6D), the spatial exaggeration is increased so that the corresponding spoken responses are perceived as having sound sources farther apart in space, thereby allowing a user to more easily distinguish between objects that are close together. In contrast, if the objects are relatively far apart (e.g., FIG. 6B), the spatial exaggeration is decreased, e.g., as respective spoken responses that virtually emanate from near the objects may already be perceived as sufficiently far apart to allow the user to distinguish between the objects. In some examples, if the distance between the objects is greater than a threshold distance, device 500 does not output a spatially exaggerated spoken response that corresponds to the objects, e.g., and instead outputs a spoken response that virtually emanates from the actual respective positions of the objects.

FIGS. 6E-6G illustrate another example of spoken responses that are provided using 3D audio effects. In FIG. 6E, the scene includes the user, leftover pasta 672 in refrigerator 670, and cheese 674 in refrigerator 670. Leftover pasta 672 has position 676 and cheese 674 has position 678. In FIG. 6E, device 500 captures image data that depicts leftover pasta 672 and cheese 674 in refrigerator 670. Based on the image data, and without receiving any natural language input, the DA proactively infers the user intent that the user is searching for something to cat. Based on the user intent, the DA further determines leftover pasta 672 and cheese 674 as being objects of relevance to the user intent.

In FIGS. 6F-6G, device 500 audibly outputs spoken response 680 to fulfill the user intent. Device 500 audibly outputs spoken response 680 by first outputting portion 680-1 (“you have leftover pasta here”) of spoken response 680 (in FIG. 6F) and by then outputting portion 680-2 (“and cheese right here”) of spoken response 680 (in FIG. 6G). Portion 680-1 virtually emanates from position 682 and portion 680-2 virtually emanates from position 684. Positions 682 and 684 are respectively based on corresponding leftover pasta 672 and cheese 674. Portion 680-1 has direction 686 relative to device 500 (as defined by angular deviation β₂ relative to front-facing direction 601), leftover pasta 672 has direction 688 relative to device 500 (as defined by angular deviation β₁ relative to front-facing direction 601), cheese 674 has direction 690 relative to device 500 (as defined by angular deviation β₃ relative to front-facing direction 601), and portion 680-2 has direction 692 relative to device 500 (as defined by angular deviation β₄ relative to front-facing direction 601). The distance between positions 682 and 684 (from which spoken response 680 virtually emanates) is greater than the distance between the corresponding leftover pasta 672 and cheese 674. Further, the difference between directions 686 and 692 of spoken response 680 is greater than the difference between directions 688 and 690 of corresponding leftover pasta 672 and cheese 674. Accordingly, spoken response 680 is a spatially exaggerated spoken response.

In FIG. 6F, device 500 displays DA virtual object 694 at position 682 while device 500 audibly outputs portion 680-1. Similarly, in FIG. 6G, device 600 displays DA virtual object 694 at position 684 while device 500 audibly outputs portion 680-2. Accordingly, in some examples, spoken response 680 appears to virtually emanate from different positions of DA virtual object 694 and DA virtual object 694 moves to indicate the currently in-focus object (e.g., 672 or 674) while device 500 outputs spoken response 680. In other examples, e.g., in FIGS. 6A-6D, device 500 provides a spatially exaggerated spoken response (e.g., 612 or 640) without displaying any virtual object. For example, in FIGS. 6A-6D, device 500 does not include any display capable of presenting XR content (e.g., XR displays 212) (or more generally, does not include any display) and device 500 provides output via auditory and/or haptic means.

In some examples, device 500 outputs a spatially exaggerated spoken response (e.g., 612, 640, or 680) if it is determined (e.g., by DA unit 350) that one or more conditions are satisfied. An example condition is satisfied when different objects within the 3D scene (e.g., 602 and 604, 630 and 632, or 672 and 674) are determined based on the user intent, e.g., as described with respect to FIGS. 6A-6B, 6C-6D, and 6E-6G. Another example condition is satisfied when DA unit 350 determines to disambiguate the user intent (e.g., disambiguate between multiple objects within the 3D scene), e.g., as described with respect to FIGS. 6A-6B and 6C-6D. Another example condition is satisfied when the distance between the different objects is less than a threshold distance (e.g., 0.1 meters, 0.2 meters, 0.5 meters, or 1 meter). For example, when the distance between the objects is greater than the threshold distance, outputting a spatially exaggerated spoken response may be unnecessary, e.g., as spoken responses that virtually emanate from the respective positions of the objects may already be perceived as sufficiently far apart to allow the user to distinguish between the objects. The particular set of conditions required to be satisfied to output (or not output) a spatially exaggerated spoken response can vary across different implementations of the examples described herein. In some examples, if one or more of the conditions are not satisfied, device 500 outputs a spoken response according to the techniques discussed above with respect to FIGS. 5A-5L, e.g., outputs a spoken response without spatial exaggeration or outputs a spoken response that emanates from a default position.

For case of description and to not obscure relevant aspects of the various examples, FIGS. 5A-5L and 6A-6G describe various directions by using a single respective angle that is defined relative to a particular direction, e.g., front-facing direction 504 or 601. However, one of ordinary skill in the art will appreciate that a direction in a 3D scene can be defined by two respective angles (e.g., a polar angle and an azimuthal angle in a coordinate system centered at device 500 (or at a user who holds, wears, or otherwise physically contacts device 500)) and that the principles discussed above with respect to FIGS. 5A-5L and 6A-6G apply analogously to directions defined by two angles. For example, a first direction corresponds to a second direction when the respective polar angles of the first and second direction differ by less than a predetermined amount and/or when the respective azimuthal angles of the first and second direction differ by less than a predetermined amount. And in some examples, a difference between a first direction and a second direction (e.g., the direction of an object and the direction of a spoken response that corresponds to an object, the direction of a first object and a direction of a second object, or a direction between a first spoken response and a second spoken response) is defined by a difference between the respective radial angles of the first and second directions and/or by a difference between the respective azimuthal angles of the first and second directions.

Further, for ease of description, some right panels of FIGS. 5A-5L and FIGS. 6A-6G illustrate that various directions and various positions are oriented to the left of or to the right of device 500 and/or the user. However, one of ordinary skill in the art will appreciate that the techniques discussed above with respect to FIGS. 5A-5L and FIGS. 6A-6G apply analogously to any direction and position in the 3D space surrounding device 500 (e.g., directions and positions above, below, to the right of, to the left of, in front of, and/or behind, device 500 and/or the user). For example, a default position from which a spoken response virtually emanates is to the right of the user and also above the user. As another example, a spoken response that corresponds to two objects that are respectively above and below the user virtually emanates from two corresponding positions that are also respectively above and below the user. As another example, a spoken response is spatially exaggerated to virtually emanate from positions that are respectively higher than and lower than the actual respective positions of the two objects that correspond to the spoken response.

Additional descriptions regarding FIGS. 5A-5L are provided below in reference to method 700 described below with respect to FIG. 7. Additional descriptions regarding FIGS. 6A-6G are provided below in reference to method 800 described below with respect to FIG. 8.

FIG. 7 is a flow diagram of a method 700 for providing spoken responses using 3D audio effects, according to some examples. In some examples, method 700 is performed at a computer system (e.g., computer system 101 in FIG. 1 and/or device 500) that is in communication with one or more sensor devices (e.g., image sensors, light sensors, depth sensors, tactile sensors, orientation sensors, proximity sensors, temperature sensors, location sensors, motion sensors, velocity sensors, audio sensors, and/or biometric sensors). In some examples, method 700 is governed by instructions that are stored in a non-transitory (or transitory) computer-readable storage medium and that are executed by one or more processors of a computer system, such as the one or more processing unit(s) 302 of computer system 101 (e.g., controller 110 in FIG. 1). In some examples, the operations of method 700 are distributed across multiple computer systems, e.g., a computer system and a separate server system. Some operations in method 700 are, optionally, combined, the orders of some operations are, optionally, changed, and some operations are, optionally, omitted.

At block 702, first data is detected (e.g., received or captured) via the one or more sensor devices.

At block 706, in response to (704) detecting, via the one or more sensor devices, the first data and after a user intent is determined (e.g., by DA unit 350) based on the first data: it is determined (e.g., by DA unit 350) whether the user intent is a first type of user intent (e.g., a multi-object intent), a second type of user intent (e.g., a default intent), or a third type of user intent (e.g., a single object intent).

At block 710, in accordance with a determination that the user intent is a first type of user intent and in accordance with a determination (708) (e.g., by DA unit 350) that a set of criteria is satisfied: a first spoken response (e.g., 514 or 540) that is generated based on the user intent is audibly output. Audibly outputting the first spoken response includes: audibly outputting (712) a first portion of the first spoken response (e.g., 514-1 or 540-1), wherein the first portion of the first spoken response virtually emanates from a first position (e.g., 506, 518, or 542) within a three-dimensional (3D) scene associated with the computer system (e.g., a 3D scene that a user of the computer system (or their avatar) is present within), and wherein the first position is based on a first object (e.g., 510 or 534); and after audibly outputting the first portion of the first spoken response, audibly outputting (714) a second portion of the first spoken response (e.g., 514-2 or 540-2), wherein the second portion of the first spoken response virtually emanates from a second position (e.g., 508, 520 or 548) within the 3D scene that is different from the first position, and wherein the second position is based on a second object (e.g., 512 or 532) different from the first object.

At block 716, in accordance with a determination that the user intent is a second type of user intent different from the first type of user intent: a second spoken response (e.g., 574) that is generated based on the user intent is audibly output, wherein the second spoken response emanates from (e.g., virtually emanates from or physically emanates from) a default position (e.g., 576) different from the first position and the second position.

In some examples, at block 718, in response to detecting, via the one or more sensor devices, the first data and after the user intent is determined based on the first data and in accordance with a determination that the user intent is a third type of user intent different from the first type of user intent and the second type of user intent: a third spoken response (e.g., 562) that is generated based on the user intent is audibly output, wherein the third spoken response virtually emanates from a third position (e.g., 564) within the 3D scene, wherein the third position is based on a third object (e.g., 556).

In some examples, the user intent is the third type of user intent when a single position of a single object (e.g., 556) is identified based on the user intent.

In some examples, the computer system is in communication with one or more front-facing image sensors and when the first data is detected, the third object (e.g., 556) is not in a field of view of the one or more front-facing image sensors (e.g., as described with respect to FIG. 5H).

In some examples, audibly outputting the third spoken response includes audibly outputting information about (e.g., location of, identity of, and/or characteristics of) the third object (e.g., as described with respect to FIG. 5I).

In some examples, the one or more sensor devices include one or more audio sensors and the first data includes a natural language input (e.g., 511, 558, or 572) detected via the one or more audio sensors.

In some examples, the one or more sensor devices include one or more audio sensors and one or more image sensors (e.g., RGB camera(s), infrared camera(s), and/or depth camera(s)); the first data includes a natural language input (e.g., 511) detected via the one or more audio sensors and image data detected via the one or more image sensors (e.g., image data representing the scene of FIG. 5A); and the user intent is determined based on the natural language input and the image data.

In some examples, the one or more sensor devices include one or more image sensors; the first data includes image data detected via the one or more image sensors (e.g., the scene of FIG. 5D); and the user intent is determined based on the image data and without receiving a natural language input.

In some examples, the user intent is the first type of user intent when multiple respective positions of multiple objects (e.g., 510 and 512, or 532 and 534) are identified based on the user intent.

In some examples, the user intent is the second type of user intent when no position of an object (e.g., any object) is identified based on the user intent, e.g., as described with respect to FIGS. 5J-5K.

In some examples, the default position (e.g., 576) is a predetermined distance away from the computer system and the default position has a predetermined direction (e.g., 578) relative to the computer system.

In some examples, the computer system is in communication with a display generation component. In some examples, method 700 further includes: while audibly outputting the first portion (e.g., 514-1) of the first spoken response, displaying, via the display generation component, a digital assistant virtual object (e.g., 516) at the first position; and while audibly outputting the second portion (e.g., 514-2) of the first spoken response, displaying, via the display generation component, the digital assistant virtual object at the second position.

In some examples, the computer system is in communication with a display generation component; the first position (e.g., 506) is the respective position of the first object (e.g., 510); the second position (e.g., 508) is the respective position of the second object (e.g., 512). In some examples, method 700 further includes: while audibly outputting the first portion (e.g., 514-1) of the first spoken response, displaying, via the display generation component, a digital assistant virtual object (e.g., 516) at a fourth position (e.g., 518) within the 3D scene, wherein the fourth position is based on the first object, and wherein the fourth position is different from the first position; and while audibly outputting the second portion (e.g., 514-2) of the first spoken response, displaying, via the display generation component, the digital assistant virtual object at a fifth position (e.g., 520) within the 3D scene, wherein the fifth position is based on the second object, and wherein the fifth position is different from the second position.

In some examples, the first spoken response (e.g., 540) is audibly output without displaying any virtual object (or without displaying a digital assistant virtual object, e.g., 516) (e.g., without displaying any virtual object while the first spoken response is audibly output); and the second spoken response (e.g., 574) is audibly output without displaying any virtual object (or without displaying a digital assistant virtual object) (e.g., without displaying any virtual object while the second spoken response is audibly output). In some examples, the third spoken response (e.g., 562) is audibly output without displaying any virtual object.

In some examples, the computer system is in communication with one or more front-facing image sensors and when the first data is detected, at least one of the first object (e.g., 532 or 534) and the second object (e.g., 532 or 534) are not in a field of view of the one or more front-facing image sensors, e.g., as illustrated in FIG. 5E.

In some examples, method 700 includes: while audibly outputting the first spoken response (e.g., 540-1 or 540-2), detecting a change in a pose of a user of the computer system (e.g., as illustrated by the transition between FIG. 5E-5F or by the transition between FIGS. 5F-5G); and in response to detecting the change in the pose of the user: in accordance with a determination that the change in the pose of the user is detected while audibly outputting the first portion (e.g., 540-1) of the first spoken response, continuing to audibly output the first portion of the first spoken response, wherein the continued audible output of the first portion of the first spoken response continues to virtually emanate from the first position (e.g., 542) (e.g., as illustrated by the transition between FIGS. 5E-5F); and in accordance with a determination that the change in the pose of the user is detected while audibly outputting the second portion (e.g., 540-2) of the first spoken response, continuing to audibly output the second portion of the first spoken response, wherein the continued audible output of the second portion of the first spoken response continues to virtually emanate from the second position (e.g., 548) (e.g., as illustrated by the transition between FIGS. 5F-5G).

In some examples, the first portion (e.g., 514-1 or 540-1) of the first spoken response has a first direction (e.g., 522 or 544) relative to the computer system, wherein the first direction relative to the computer system corresponds to the respective direction of the first object (e.g., 526 or 546) relative to the computer system; and the second portion (e.g., 514-2 or 540-2) of the first spoken response has a second direction (e.g., 524 or 550) relative to the computer system, wherein the second direction relative to the computer system corresponds to the respective direction of the second object (e.g., 528 or 552) relative to the computer system, wherein the first direction relative to the computer system is different from the second direction relative to the computer system.

In some examples, the first position (e.g., 518 or 542) is within a predetermined distance from the respective position of the first object (e.g., 506 or 538) and the second position (e.g., 520 or 548) is within the predetermined distance from the respective position of the second object (e.g., 508 or 536).

In some examples, the first portion (e.g., 514-1 or 540-1) of the first spoken response provides information about (e.g., location of, identity of, and/or characteristics of) the first object (e.g., 510 or 534) the second portion (e.g., 514-2 or 540-2) of the first spoken response provides information about (e.g., location of, identity of, and/or characteristics of) the second object (e.g., 512 or 532).

In some examples, the first spoken response (e.g., 514) corresponds to a request for user disambiguation between the first object and the second object.

In some examples, the set of criteria is satisfied when the respective position of the first object (e.g., 506 or 538) and the respective position of the second object (e.g., 508 or 536) are each within a threshold distance from the computer system.

In some examples, method 700 further includes: detecting, via the one or more sensor devices, an air gesture (e.g., 580), wherein the air gesture corresponds to a selection of a respective object (e.g., 582) within the 3D scene; and in response to detecting the air gesture, providing an audible output (e.g., 584) that virtually originates from a position (e.g., 586) of the air gesture and that virtually moves in a direction (e.g., 588) of the respective object relative to the computer system. In some examples, the audible output virtually ceases at the position of the respective object.

In some examples, in accordance with a determination that the respective object (e.g., 582) has a first object characteristic, the audible output (e.g., 584) has a first sound characteristic that is based on the first object characteristic; and in accordance with a determination that the respective object has a second object characteristic different from the first object characteristic, the audible output has a second sound characteristic that is based on the second object characteristic, wherein the second sound characteristic is different from the first sound characteristic.

FIG. 8 is a flow diagram of a method 800 for providing spoken responses using 3D audio effects, according to some examples. In some examples, method 800 is performed at a computer system (e.g., computer system 101 in FIG. 1 and/or device 500) that is in communication with one or more sensor devices (e.g., image sensors, light sensors, depth sensors, tactile sensors, orientation sensors, proximity sensors, temperature sensors, location sensors, motion sensors, velocity sensors, audio sensors, and/or biometric sensors). In some examples, method 800 is governed by instructions that are stored in a non-transitory (or transitory) computer-readable storage medium and that are executed by one or more processors of a computer system, such as the one or more processing unit(s) 302 of computer system 101 (e.g., controller 110 in FIG. 1). In some examples, the operations of method 800 are distributed across multiple computer systems, e.g., a computer system and a separate server system. Some operations in method 800 are, optionally, combined, the orders of some operations are, optionally, changed, and some operations are, optionally, omitted.

At block 802, first data is detected via the one or more sensor devices.

At block 806, in response to (804) detecting, via the one or more sensor devices, the first data and after a user intent is determined (e.g., by DA unit 350) based on the first data: it is determined (e.g., by DA unit 350) whether a set of criteria is satisfied, wherein the set of criteria includes a first criterion that is satisfied when a first object (e.g., 602, 630, or 672) and a second object (e.g., 604, 632, or 674) different from the first object are respectively determined based on the user intent.

At block 808, in accordance with a determination that the set of criteria is satisfied, a spoken response (e.g., 612, 640, or 680) that is determined based on the user intent is audibly output. Audibly outputting the spoken response includes: audibly outputting (810) a first portion (e.g., 621-1, 640-1, or 680-1) of the spoken response that virtually emanates from a first position (e.g., 614, 642, or 682) within a three-dimensional (3D) scene associated with the computer system; and after audibly outputting the first portion of the spoken response, audibly outputting a second portion (e.g., 612-2, 640-2, or 680-2) of the spoken response that virtually emanates from a second position (e.g., 616, 644, or 684) within the 3D scene that is different from the first position, wherein: the first position is based on the first object (e.g., 602, 630, or 672); and the second position is based on the second object (e.g., 604, 632, or 674). In some examples, the distance (e.g., 620 or 646) between the first position and the second position is greater than the distance (e.g., 618 or 648) between the first object and the second object.

At block 814, in accordance with a determination that the set of criteria is not satisfied, audibly outputting the spoken response is forgone. In some examples, method 700 includes: in accordance with a determination that the set of criteria is not satisfied, audibly outputting another spoken response. In some examples, the other spoken response depends on the user intent, e.g., as described with respect to FIGS. 5A-5L.

In some examples, the one or more sensor devices include one or more audio sensors and the first data includes a first natural language input (e.g., 610 or 638) detected via the one or more audio sensors.

In some examples, the spoken response (e.g., 612 or 640) is audibly output without detecting a natural language input further to the first natural language input, e.g., as illustrated by FIG. 6A-6B or by FIGS. 6C-6D.

In some examples, the one or more sensor devices include one or more audio sensors and one or more image sensors (e.g., RGB camera(s), infrared camera(s), and/or depth camera(s)); the first data includes a natural language input (e.g., 610 or 638) detected via the one or more audio sensors and image data detected via the one or more image sensors (e.g., as described with respect to FIG. 6A or FIG. 6C); and the user intent is determined based on the natural language input and the image data.

In some examples, the one or more sensor devices include one or more image sensors; the first data includes image data detected via the one or more image sensors (e.g., as described with respect to FIG. 6E); and the user intent is determined based on the image data and without receiving a natural language input (e.g., as described with respect to FIG. 6E).

In some examples, the distance between the first position and the first object (e.g., the distance between positions 614 and 606 or the distance between positions 642 and 634) is inversely related to the distance between the first object and the second object (e.g., 618 or 648) and the distance between the second position and the second object (e.g., the distance between positions 616 and 608 or the distance between positions 644 and 636) is inversely related to the distance between the first object and the second object.

In some examples, the first object has a first object direction (e.g., 622 or 650) relative to the computer system; the second object has a second object direction (e.g., 626 or 654) relative to the computer system; the first portion of the spoken response has a first audio direction (e.g., 624 or 652) relative to the computer system; the second portion of the spoken response has a second audio direction (e.g., 628 or 656) relative to the computer system; and the difference between the first audio direction and the second audio direction is greater than the difference between the first object direction and the second object direction.

In some examples, the set of criteria include a second criterion that is satisfied when a determination is made (e.g., by DA unit 350) to disambiguate the user intent and the spoken response (e.g., 612 or 640) corresponds to a request for user disambiguation between the first object and the second object.

In some examples, the set of criteria include a third criterion that is satisfied when the distance between the first object and the second object is less than a threshold distance.

In some examples, the first portion (e.g., 612-1, 640-1, or 680-1) of the spoken response has a first direction (e.g., 624, 652, or 686) relative to the computer system, wherein the first direction relative to the computer system corresponds to the respective direction (e.g., 622, 650, or 688) of the first object relative to the computer system; and the second portion (e.g., 612-2, 640-2, or 680-2) of the spoken response has a second direction (e.g., 628, 656, or 692) relative to the computer system, wherein the second direction relative to the computer system corresponds to the respective direction (e.g., 626, 654, or 690) of the second object relative to the computer system, wherein the first direction relative to the computer is different from the second direction relative to the computer system.

In some examples, the first position (e.g., 614, 642, or 682) is within a predetermined distance from the respective position (e.g., 606, 634, or 676) of the first object and the second position (e.g., 616, 644, or 684) is within the predetermined distance from the respective position (e.g., 608, 636, or 678) of the second object.

In some examples, the computer system is in communication with a display generation component. In some examples, method 700 further includes: while audibly outputting the first portion (e.g., 680-1) of the spoken response, displaying, via the display generation component, a digital assistant virtual object (e.g., 694) at the first position (e.g., 682); and while audibly outputting the second portion (e.g., 680-2) of the spoken response, displaying, via the display generation component, the digital assistant virtual object at the second position (e.g., 684).

In some examples, the spoken response (e.g., 612 or 640) is audibly output without displaying any virtual object (e.g., without displaying a digital assistant virtual object) (e.g., without displaying any virtual object while the spoken response is audibly output).

In some examples, the first portion of the spoken response provides information about (e.g., location of, identity of, and/or characteristics of) the first object and the second portion of the spoken response provides information about (e.g., location of, identity of, and/or characteristics of) the second object.

In some examples, the computer system is in communication with one or more front-facing image sensors and when the first data is detected, at least one of the first object and the second object are not in a field of view of the one or more front-facing image sensors.

In some examples, aspects/operations of methods 700 and 800 may be interchanged, substituted, and/or added between these methods. For example, if the set of criteria for method 800 are not satisfied (at block 806), method 800 includes conditionally audibly outputting the first spoken response (block 708), the second spoken response (block 716), or the third spoken response (block 718), depending on the type of the user intent. For brevity, further details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to facilitate user interactions with a three-dimensional scene. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to output spoken responses to assist a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of outputting spoken responses for the user, the present technology can be configured to allow users to select to “opt in” or “opt out” of participation in the collection of personal information data during registration for services or anytime thereafter. In another example, users can select not to provide personal information data based on which on spoken responses are generated. In yet another example, users can select to limit the length of time for which such data is maintained. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, spoken responses can be generated based on non-personal information data or a bare minimum amount of personal information, such as the content being requested by the device associated with a user, other non-personal information available to the service, or publicly available information.

What is claimed is:

1. A computer system configured to communicate with one or more sensor devices, the computer system comprising:
one or more processors; and
memory storing one or more programs configured to be executed by the one or more processors, the one or more programs including instructions for:
detecting, via the one or more sensor devices, first data; and
in response to detecting, via the one or more sensor devices, the first data and after a user intent is determined based on the first data:
in accordance with a determination that the user intent is a first type of user intent and a determination that a set of criteria is satisfied:
audibly outputting a first spoken response that is generated based on the user intent, wherein audibly outputting the first spoken response includes:
audibly outputting a first portion of the first spoken response, wherein the first portion of the first spoken response virtually emanates from a first position within a three-dimensional (3D) scene associated with the computer system, and wherein the first position is based on a first object; and
after audibly outputting the first portion of the first spoken response, audibly outputting a second portion of the first spoken response, wherein the second portion of the first spoken response virtually emanates from a second position within the 3D scene that is different from the first position, and wherein the second position is based on a second object different from the first object; and
in accordance with a determination that the user intent is a second type of user intent different from the first type of user intent:
audibly outputting a second spoken response that is generated based on the user intent, wherein the second spoken response emanates from a default position different from the first position and the second position.

2. The computer system of claim 1, wherein the one or more programs further include instructions for:
in response to detecting, via the one or more sensor devices, the first data and after the user intent is determined based on the first data:
in accordance with a determination that the user intent is a third type of user intent different from the first type of user intent and the second type of user intent:
audibly outputting a third spoken response that is generated based on the user intent, wherein the third spoken response virtually emanates from a third position within the 3D scene, wherein the third position is based on a third object.

3. The computer system of claim 2, wherein the user intent is the third type of user intent when a single position of a single object is identified based on the user intent.

4. The computer system of claim 2, wherein:
the computer system is in communication with one or more front-facing image sensors; and
when the first data is detected, the third object is not in a field of view of the one or more front-facing image sensors.

5. The computer system of claim 2, wherein audibly outputting the third spoken response includes audibly outputting information about the third object.

6. The computer system of claim 1, wherein:
the one or more sensor devices include one or more audio sensors; and
the first data includes a natural language input detected via the one or more audio sensors.

7. The computer system of claim 1, wherein:
the one or more sensor devices include one or more audio sensors and one or more image sensors;
the first data includes a natural language input detected via the one or more audio sensors and image data detected via the one or more image sensors; and
the user intent is determined based on the natural language input and the image data.

8. The computer system of claim 1, wherein:
the one or more sensor devices include one or more image sensors;
the first data includes image data detected via the one or more image sensors; and
the user intent is determined based on the image data and without receiving a natural language input.

9. The computer system of claim 1, wherein the user intent is the first type of user intent when multiple respective positions of multiple objects are identified based on the user intent.

10. The computer system of claim 1, wherein the user intent is the second type of user intent when no position of an object is identified based on the user intent.

11. The computer system of claim 1, wherein the default position is a predetermined distance away from the computer system and wherein the default position has a predetermined direction relative to the computer system.

12. The computer system of claim 1, wherein the computer system is in communication with a display generation component, and wherein the one or more programs further include instructions for:
while audibly outputting the first portion of the first spoken response, displaying, via the display generation component, a digital assistant virtual object at the first position; and
while audibly outputting the second portion of the first spoken response, displaying, via the display generation component, the digital assistant virtual object at the second position.

13. The computer system of claim 1, wherein:
the computer system is in communication with a display generation component;
the first position is a respective position of the first object;
the second position is a respective position of the second object; and
the one or more programs further include instructions for:
while audibly outputting the first portion of the first spoken response, displaying, via the display generation component, a digital assistant virtual object at a fourth position within the 3D scene, wherein the fourth position is based on the first object, and wherein the fourth position is different from the first position; and
while audibly outputting the second portion of the first spoken response, displaying, via the display generation component, the digital assistant virtual object at a fifth position within the 3D scene, wherein the fifth position is based on the second object, and wherein the fifth position is different from the second position.

14. The computer system of claim 1, wherein:
the first spoken response is audibly output without displaying any virtual object; and
the second spoken response is audibly output without displaying any virtual object.

15. The computer system of claim 1, wherein:
the computer system is in communication with one or more front-facing image sensors; and
when the first data is detected, at least one of the first object and the second object are not in a field of view of the one or more front-facing image sensors.

16. The computer system of claim 1, wherein the one or more programs further include instructions for:
while audibly outputting the first spoken response, detecting a change in a pose of a user of the computer system; and
in response to detecting the change in the pose of the user:
in accordance with a determination that the change in the pose of the user is detected while audibly outputting the first portion of the first spoken response, continuing to audibly output the first portion of the first spoken response, wherein the continued audible output of the first portion of the first spoken response continues to virtually emanate from the first position; and
in accordance with a determination that the change in the pose of the user is detected while audibly outputting the second portion of the first spoken response, continuing to audibly output the second portion of the first spoken response, wherein the continued audible output of the second portion of the first spoken response continues to virtually emanate from the second position.

17. The computer system of claim 1, wherein:
the first portion of the first spoken response has a first direction relative to the computer system, wherein the first direction relative to the computer system corresponds to the respective direction of the first object relative to the computer system; and
the second portion of the first spoken response has a second direction relative to the computer system, wherein the second direction relative to the computer system corresponds to the respective direction of the second object relative to the computer system, wherein the first direction relative to the computer system is different from the second direction relative to the computer system.

18. The computer system of claim 1, wherein:
the first position is within a predetermined distance from a respective position of the first object; and
the second position is within the predetermined distance from a respective position of the second object.

19. The computer system of claim 1, wherein:
the first portion of the first spoken response provides information about the first object; and
the second portion of the first spoken response provides information about the second object.

20. The computer system of claim 1, wherein the first spoken response corresponds to a request for user disambiguation between the first object and the second object.

21. The computer system of claim 1, wherein the set of criteria is satisfied when the respective position of the first object and the respective position of the second object are each within a threshold distance from the computer system.

22. The computer system of claim 1, wherein the one or more programs further include instructions for:
detecting, via the one or more sensor devices, an air gesture, wherein the air gesture corresponds to a selection of a respective object within the 3D scene; and
in response to detecting the air gesture, providing an audible output that virtually originates from a position of the air gesture and that virtually moves in a direction of the respective object relative to the computer system.

23. The computer system of claim 22, wherein:
in accordance with a determination that the respective object has a first object characteristic, the audible output has a first sound characteristic that is based on the first object characteristic; and
in accordance with a determination that the respective object has a second object characteristic different from the first object characteristic, the audible output has a second sound characteristic that is based on the second object characteristic, wherein the second sound characteristic is different from the first sound characteristic.

24. A non-transitory computer-readable storage medium storing one or more programs configured to be executed by one or more processors of a computer system that is in communication with one or more sensor devices, the one or more programs including instructions for:
detecting, via the one or more sensor devices, first data; and
in response to detecting, via the one or more sensor devices, the first data and after a user intent is determined based on the first data:
in accordance with a determination that the user intent is a first type of user intent and a determination that a set of criteria is satisfied:
audibly outputting a first spoken response that is generated based on the user intent, wherein audibly outputting the first spoken response includes:
audibly outputting a first portion of the first spoken response, wherein the first portion of the first spoken response virtually emanates from a first position within a three-dimensional (3D) scene associated with the computer system, and wherein the first position is based on a first object; and
after audibly outputting the first portion of the first spoken response, audibly outputting a second portion of the first spoken response, wherein the second portion of the first spoken response virtually emanates from a second position within the 3D scene that is different from the first position, and wherein the second position is based on a second object different from the first object; and
in accordance with a determination that the user intent is a second type of user intent different from the first type of user intent:
audibly outputting a second spoken response that is generated based on the user intent, wherein the second spoken response emanates from a default position different from the first position and the second position.

25. A method, comprising:
at a computer system that is in communication with one or more sensor devices:
detecting, via the one or more sensor devices, first data; and
in response to detecting, via the one or more sensor devices, the first data and after a user intent is determined based on the first data:
in accordance with a determination that the user intent is a first type of user intent and a determination that a set of criteria is satisfied:
audibly outputting a first spoken response that is generated based on the user intent, wherein audibly outputting the first spoken response includes:
audibly outputting a first portion of the first spoken response, wherein the first portion of the first spoken response virtually emanates from a first position within a three-dimensional (3D) scene associated with the computer system, and wherein the first position is based on a first object; and
after audibly outputting the first portion of the first spoken response, audibly outputting a second portion of the first spoken response, wherein the second portion of the first spoken response virtually emanates from a second position within the 3D scene that is different from the first position, and wherein the second position is based on a second object different from the first object; and
in accordance with a determination that the user intent is a second type of user intent different from the first type of user intent:
audibly outputting a second spoken response that is generated based on the user intent, wherein the second spoken response emanates from a default position different from the first position and the second position.
